(19) United States
(12) Patent Application Publication
(10) Pub. No.: US 2022/0327555 A1
(43) Pub. Date: Oct. 13, 2022

(54) RESEARCH BASED MIXED MODE/HYBRID OPERATING SYSTEM AND METHOD

(71) Applicant: Aubrey Jones, Oklahoma City, OK (US)

(72) Inventor: Aubrey Jones, Oklahoma City, OK (US)

(73) Assignee: Aubrey Jones, Oklahoma City, OK (US)

(21) Appl. No.: 17/697,246

(22) Filed: Mar. 17, 2022

Related U.S. Application Data
(63) Continuation-in-part of application No. 17/225,355, filed on Apr. 8, 2021, now abandoned.

(51) Int. Cl. G06Q 30/02

(52) U.S. Cl. CPC G06Q 30/0201

(57) ABSTRACT

A combination computer-based information system (CBIS) and computer-implemented method using a mixed-mode/hybrid computer-based operating system in consumer financial services and marketing strategies for providers and consumers using data science(s) and reciprocatively Socratic teaching and learning communication methodologies is disclosed. The system and method create a digital pathway to inclusion, accelerating branding, and national distribution channels.

### RELATED APPLICATIONS

This application is a continuation-in-part of U.S. patent application Ser. No. 17/225,355 entitled “System and Computer-Implemented Method for Creating Digital Pathways Between Financial Service Providers and Consumers,” filed Apr. 8, 2021, which claims the benefit of U.S. Provisional Patent Application Ser. No. 63/007,318, entitled “System and Computer-Implemented Method for Creating Digital Pathways Between Financial Service Providers and Consumers” filed Apr. 8, 2020, the disclosure of which are hereby incorporated by reference.

### FIELD OF THE INVENTION

This invention generally relates to a system and computer-implemented method for creating digital pathways between scientists, researchers, policymakers, and educators, and end-users/consumers, and more specifically to mixed-mode/hybrid computer-based operating systems and computer-implemented methods in scientific research and marketing strategies using data science(s) and reciprocatively Socratic teaching and learning communication methodologies.

### BACKGROUND OF THE INVENTION

Exclusion from digital pathways creates inequities in the financial lives of consumers, making it more costly and riskier for them to perform basic financial activities or receive access to the same options as other consumers. It also makes it costlier for providers in the financial services industry to perform transactions with those consumers. Current digital systems have been proven to be problematic and inaccessible, from a financial, information, and geographical perspective, to both institutions and consumers within the financial services industry and other consumer-facing industries. A growing body of evidence indicates that connecting consumers to a comprehensive digital financial system will generate sizable benefits for consumers and businesses in the financial service industry.

It is therefore desirable to provide an improved system and computer-implemented method for creating digital pathways between scientists, researchers, educators, and service providers and consumers who utilize various financial services and other consumer-based services (such as travel systems, utilities, subscription services, insurance, etc.).

It is further desirable to provide combined computer-based information systems and computer-implemented methods in consumer financial services and marketing strategies for providers and consumers using data science(s) and reciprocatively Socratic teaching and learning communication methodologies.

It is still further desirable to provide a system and computer-implemented method that creates a digital pathway to inclusion, accelerating branding, and national distribution channels.

Before proceeding to a detailed description of the invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

In general, the invention relates a system and computer-implemented method for creating digital pathways between financial service providers and consumers, and more specifically to combined computer-based information systems, computer-based operating systems, and computer-implemented methods in consumer financial services, consumer end solutions and products, and marketing strategies for providers and consumers using data science(s) and reciprocatively Socratic teaching and learning communication methodologies. The invention also relates to a system and method for incorporating the following method and system into a platform as a service (PaaS) technology.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 is a flow chart of a system using a mixed-mode/hybrid operating system in accordance with an illustrative embodiment of the invention disclosed herein.

FIG. 2 is a flow chart of a scientific method in accordance with an illustrative embodiment of the invention disclosed herein

FIG. 3 is a flow chart of a critical thinking process in accordance with an illustrative embodiment of the invention disclosed herein.

FIG. 4 is a flow chart of a consumer research process in accordance with an illustrative embodiment of the invention disclosed herein.

FIG. 5 is an exemplary graphical user interface user frontend in accordance with an illustrative embodiment of the invention disclosed herein.

FIG. 6 is another exemplary graphical user interface user frontend in accordance with an illustrative embodiment of the invention disclosed herein.

FIG. 7 is another exemplary graphical user interface user frontend in accordance with an illustrative embodiment of the invention disclosed herein.

FIG. 8 is another exemplary graphical user interface user frontend in accordance with an illustrative embodiment of the invention disclosed herein.

FIG. 9 is another exemplary graphical user interface lender backend in accordance with an illustrative embodiment of the invention disclosed herein.

FIG. 10 is another exemplary graphical user interface lender backend in accordance with an illustrative embodiment of the invention disclosed herein.

FIG. 11 is another exemplary graphical user interface lender backend in accordance with an illustrative embodiment of the invention disclosed herein.

FIG. 12 is another exemplary graphical user interface lender backend in accordance with an illustrative embodiment of the invention disclosed herein.

FIG. 13 is exemplary graphical user interface in accordance with an illustrative embodiment of the invention disclosed herein.

FIG. 14 is exemplary graphical user interface in accordance with an illustrative embodiment of the invention disclosed herein.

### DETAILED DESCRIPTION OF THE INVENTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

This invention generally relates to a system and computer-implemented method for creating digital pathways between scientists, researchers, policymakers, and educators, and end-users/consumers, and more specifically to a mixed mode/hybrid computer-based operating systems and computer-implemented methods in scientific research and marketing strategies using data science(s) and reciprocatively Socratic teaching and learning communication methodologies.

The inventive system and computer-implemented method provide for an integrated digital system and method where consumers will experience direct benefits through several digital pathway channels. Due to the learning process of the system, a range of service providers can offer the best possible products to consumers allowing their customers/potential customers to choose which offering is best for them, while enabling the service providers to concentrate on the product design and marketing. Moreover, the system and computer-implemented method disclosed herein creates an interactive marketing platform between consumers and service providers by applying educational sciences to improve the knowledge and communal connectivity of both parties.

Currently, there are no clear digital pathways to widespread financial inclusion, and current systems and methods provide incomplete and probabilistic information creating inequities by making financial activities costlier and riskier for them to perform. Current systems and methods fail consumers by making it costly for providers/lenders to transact with them.

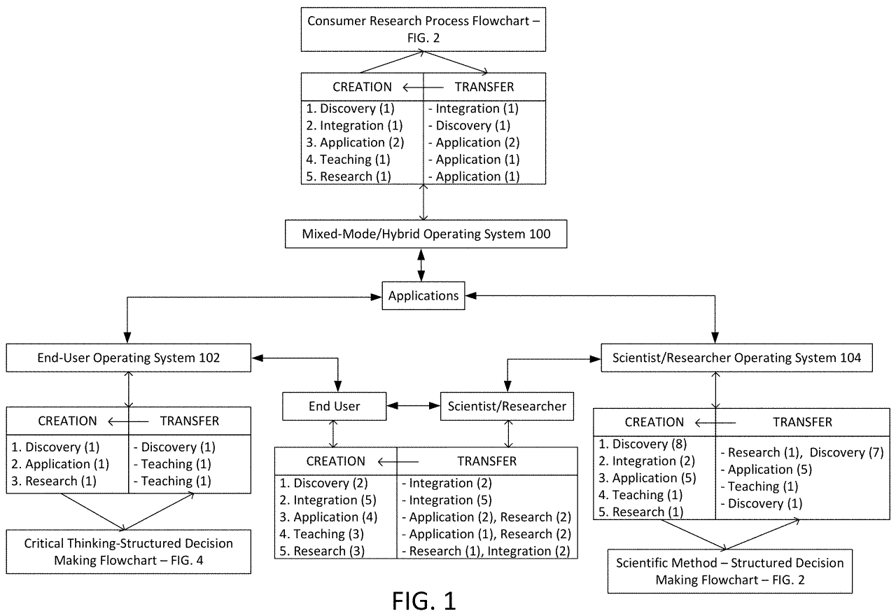

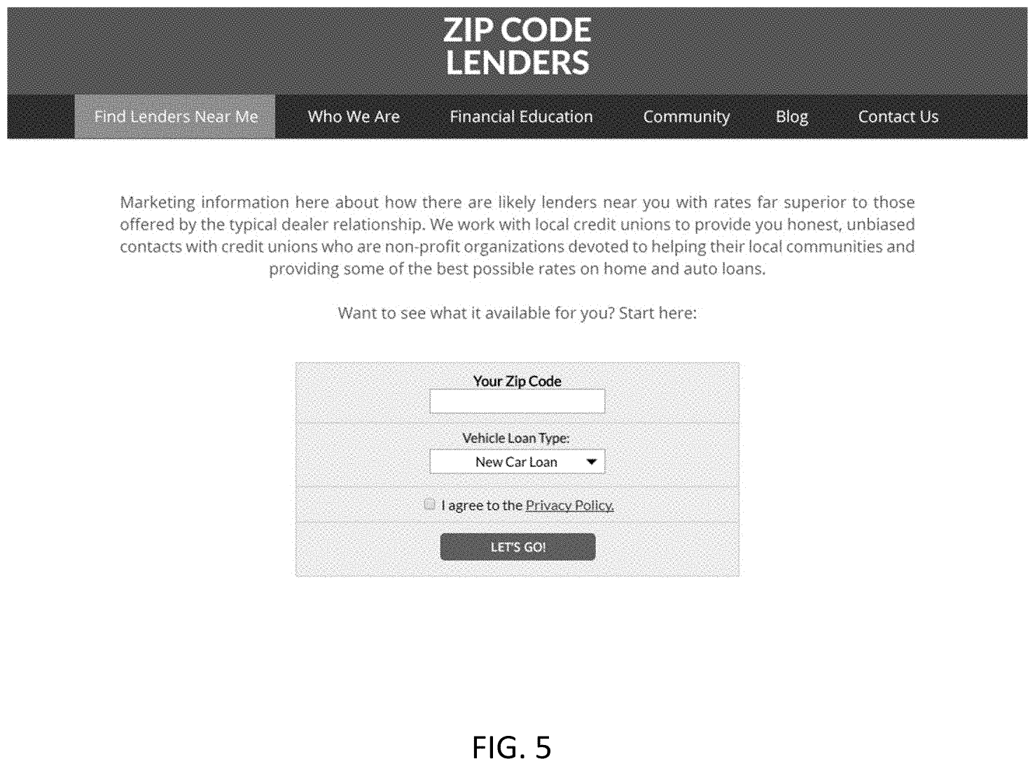

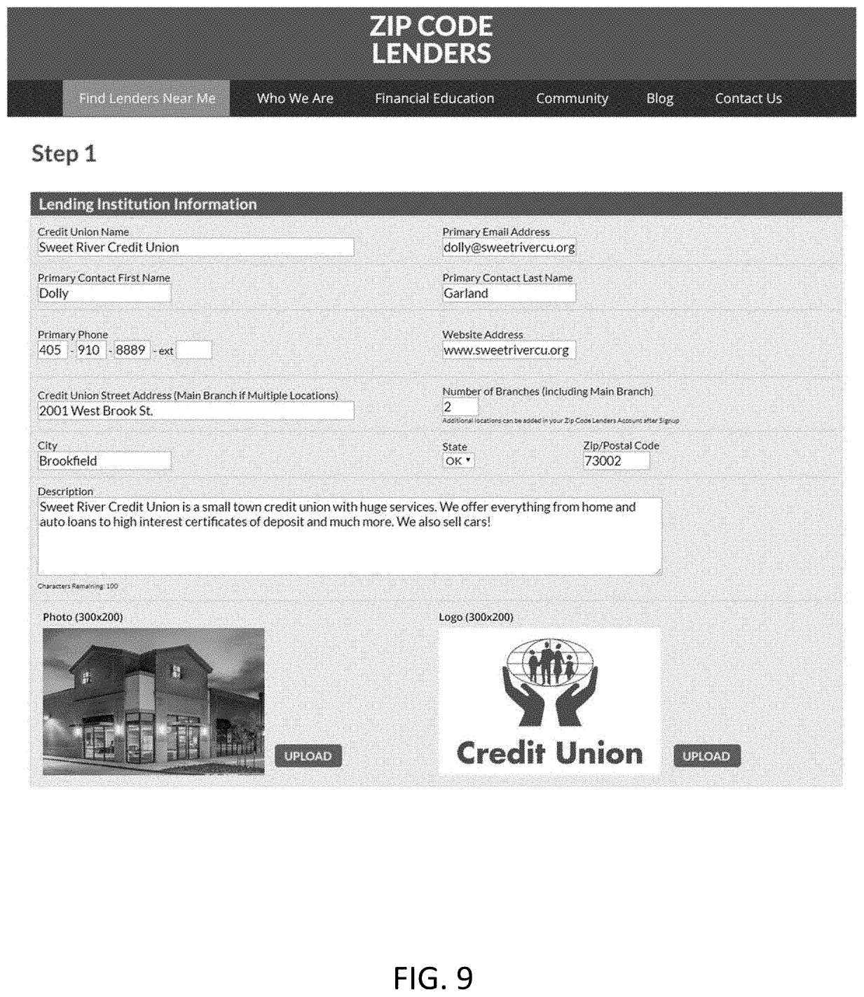

The inventive system and computer-implemented method may include data analytics (FIGS. 1-4), a user or consumer frontend (FIGS. 5-8), and a service provider backend (FIGS. 9-14). As illustrated in FIG. 1, the use of a mixed-mode/hybrid operating system 100 is shown. The system 100 includes an end-user operating system 102, which interfaces with the consumer/public, and a scientist/researcher operating system 104, which may be used to replicate, aggregate, and analyze the data gathered by the end-user operating system 102. These systems interact with the end user (consumer) and the scientist (it will be understood that although the term scientist is used throughout, the term scientist is interchangeable with any person who can use the data collected and processed including scientists, service providers, researchers, educators, policymakers, and the like) through the use of a graphical user interface (GUI) or other similar type of human interface. The mixed mode operating system 100 is intended to provide a more intuitive user interface to allow consumers to self-construct specific and customized products and services that better meet their needs, regardless of their status in society.

It will be understood that the mixed-mode operating system 100, the end-user operating system 102, and the scientist/research operating system 104 may be located on a multitude of computers with various processing elements, a multitude of databases, and may operate in a networked environment via wired and/or wireless communications to various remote computers, including those presented to the consumer and/or scientists. The mixed-mode operating system 100 embodies novel assumptions about human cognition and applies a multi-paradigmatic approach to research. It gathers data from a multitude of sources about the consumer, the community, and other points of interest, and provides that data and analysis and conclusions about the data to researchers. This process is cyclical and iterative and can be used to identify problems in providing services to particular consumers and solve these problems in a scientific way. As further depicted in FIG. 1, the mixed mode operating system 100 uses qualitative and quantitative data to generate unique insight into complex social phenomenon that are not available for data alone. The system 100 may utilize a creation-transfer process and five core concepts to iteratively increase the digital pathways provided to the consumer.

First, the system utilizes discovery. Discovery involves the input or creation of knowledge or products using hypothesis-driven research. This research may be obtained from a variety of inputs from the consumer or from past research done on users/consumers. The discovery can include direct inputs and decision-making processes or choices of the consumer. The discovery process may also be used to produce outputs and a transfer of the knowledge by applying advanced analytics, data sciences, and social sciences from various categories of the consumer decision making process using a consumer behavioral model.

Second, the system utilizes integration. On the input/creation side of integration, the system synthesizes the knowledge gained during discovery to make it useful to the scientists. The knowledge gained may be integrated to assist users (scientists, non-scientists, consumers, researchers, and anyone who wants to use the data) to make connections to a particular discipline or an exploration that examines the data in a new way. On the output/transfer side, integration of the data obtained during discovery may assist the system, or scientists using the system, to study characteristics of the consumers, including demographics, psychographics, and behavioral variables.

Third, the system applies the knowledge and integrated data to create an improved critical thinking process and practice, systems operation, public health or policy to solve specific problems. For instance, the system can use the integrated information to estimate statistical data of groups in various categories of social and behavioral sciences to determine consumer's expectations related to certain services or products. On the output/transfer side, the system can use the data to improve literacy and critical thinking in the consumer decision-making process. Data can be applied to estimate statistical data of groups in various categories of social and behavioral sciences to determine the consumer's expectations related to those products.

Fourth, the system utilizes the information to prepare and provide instruction/teaching. For example, on the input/creation side, the data gathered and synthesized may be used by the system to develop, implement, and evaluate educational programs, materials, or other resources to educate the public, or to educate specific industries. On the output/transfer side, the system presents an information system in consumer financial services and marketing strategies for providers and consumers using data sciences and collaborative teaching and learning communication methodologies.

Fifth, the system may utilize the information to conduct additional research. On the creation/input side, the system may use the data to generate and communicate new knowledge discovered and to develop and refine methods provided to consumers. On the output/transfer side, the system presents the data to peers, other scientists, supporters of research, and the public using peer-reviewed publications and presentations, patents, public reports and presentations. Research may identify originality, scope, and significance of new knowledge, applicability and benefits to society, innovation, scope, and significance of new knowledge, applicability and benefits to society, summaries of primary contributions, significance and impact in advancing knowledge, new methods, public benefits, communication and validation by peers, and evidence of leadership and team contributions

The mixed-mode operating system and computerized method disclosed herein utilizes the following research themes to assist the development and mission of the system:
Social Sciences (SS)
Citizen-Community Science (CS)
Critical Thinking (CT)
Consumer Psychology (CP)
Communication Science (CMS)
Risk Literacy (RL)
Information Systems (IS)
Platform Theory (PT)
Design Science (DSR)
Machine Learning (ML)
Online Marketplace Lending (OML)
Cumulative Impact Analysis (CIA)
   These research themes are referenced throughout by their acronyms or in full. Additionally, some of the material herein is from additional sources, and the references to the following includes references to these sources:
Social Sciences (SS) “Social Science Research: Principles, Methods, and Practices.” https://digitalcommons.usf.edu/cgi/viewcontent.cgi?article=1002&context=oa_textbooks.
Citizen-Community Science (CS) “Citizen Science in the Social Sciences: A Call for More . . . ” https://www.researchgate.net/publication/315505441_Citizen_Science_in_the_Social_Sciences_A_Call_for_More_Evidence
Communication Science (CMS) “Evaluating science communication—ResearchGate.” https://www.researchgate.net/publication/329214406_Evaluating_science_communication.
Risk Literacy (RL) “journal.sjdm.org.” http://journal.sjdm.org/11/11808/jdm11808.pdf.
Information Systems (IS) “Paradigms and Information Systems as an applied discipline . . . ” https://www.researchgate.net/publication/221408882_Paradigms_and_Information_Systems_as_an_applied_discipline_-_A_model-based_representation_problems_and_suggested_solutions.
Platform Theory (PT) “An Outlook of Platform Theory Research in Business Studies.” https://www.researchgate.net/publication/311969906_An_Outlook_of_Platform_Theory_Research_in_Business_Studies.
Design Science (DSR) “desrist.org—design science research in information . . . ” http://desrist.org/default.aspx.
Machine Learning (ML) “Frontiers | Machine Learning in Psychometrics and . . . ” https://www.frontiersin.org/articles/10.3389/fpsyg.2019.02970/full; “PubMed.” https://pubmed.ncbi.nlm.nih.gov/31998200/.
Cumulative Impact Analysis (CIA) “Cumulative effects (environment)—Wikipedia.” https://en.wikipedia.org/wiki/Cumulative_Effects_(Environment)
Consumer Psychology (CP) “Consumer Psychology: Categorization, Inferences . . . ” https://www.researchgate.net/publication/7449574_Consumer_Psychology_Categorization_Inferences_Affect_and_Persuasion
Critical Thinking (CT, CTQ) “Critical Thinking Competency Standards.” https://www.criticalthinking.org/files/SAM_Comp %20Stand_07opt.pdf; “(PDF) Critical Thinking as a Qualified Decision-Making Tool.” https://www.researchgate.net/publication/338425319_Critical_Thinking_as_a_Qualified_Decision_Making_Tool
Financial Inclusion (FI) https://responsiblefinanceforum.org/wp-content/uploads/Pathway_Financial_Inclusion.pdf
Online Marketplace Lending (OML) https://home.treasury.gov/system/files/231/Opportunities_and_Challenges_in_Online_Marketplace_Lending_white_paper.pdf

As further depicted in FIG. 1, the mixed-mode operating system 100 involves the transfer of information between the system, the end-user, and the scientist. The system 100 is an expert system embodying novel assumptions about human cognition and the application of a multi-paradigmatic approach to research. Particularly, in application, “we understand citizen science as a partnership between professional researchers and volunteers in which the volunteers implement tasks which have traditionally been implemented by scientists” (Bonney et al. 2009). This cooperation and data creation/transfer is meant to serve two goals (CS): 1) first, it should create new scientific insights, most importantly by gathering large-scale or hidden data, which the researchers alone could not access by themselves (Raddick et al. 2010); and 2) second, the cooperation should produce an educational outcome, such as increasing knowledge and scientific interest among participants (Land-Zandstra et al. 2015). This perspective offers an approach to creating such systems by adapting scientific methods to the practical constraints of science communication (CMS). It focuses on contexts where the goal of science communication is helping people to make autonomous choices rather than promoting specific behaviors.

As depicted in FIG. 1, the end-user and scientist are in communication via the input/creation and output/transfer process through collaboration. Specifically, the system and methods may use the following levels of integration, application, and research:
Integration: Looking forward, there are many emerging opportunities to use this and other validated tests to enhance adaptive decision support systems (i.e., custom-tailored risk communication. (Lipkus et al., 2010) (RL).
Integration: Also, the exchange between scientific and other societal institutions may be important to identify existing problems in society and build participation platforms which address these problems in a scientific way. (CS)
Integration: For example, Kokuryo (2006a, 2006b, 2011), and other studies have discussed the designing, building, and operating community information platforms to revitalize local communities. In fact, Kokuryo and Platform Design Lab. (2011) notes the following five points as the key variables for designing a platform (PT):
   Integration: A “science in society” approach assumes that knowledge is no longer produced exclusively in scientific institutions, but in transdisciplinary collaborations, which aim to solve existing practical problems. Such transdisciplinary collaborations may not only involve interactions between scientific disciplines, but also between scientific and non-scientific actors (Hurni and Wiesmann 2014). In order to ensure the external legitimacy of institutionalized scientific research, scientific actors have to open up to societal actors and actively involve them in scientific knowledge production (Schneidewind and Singer-Brodowski 2014, Schneidewind 2015) (CS).
   Integration: Difficulties in mobilizing target groups. A sufficient pool of potential participants and the successful mobilization of this group is a key prerequisite for the successful implementation of a citizen science project.
   Integration: Establishing methods and strategies on how to communicate these standards among volunteers will be critical in order to promote a responsible path to the practice of citizen science within social science (CS).
   Integration: The close cooperation with citizens and the necessity to motivate them for engagement also ties research questions more closely to real existing social problems and may hence increase the social impact of research results (CS).
Research: The main object is to empower disadvantaged communities by integrating them in the scientific process and provide them with the tools and the knowledge to make a change (CS).
Application: The goal is not to effect specific changes but to empower people to make better informed choices (CMS).
Application: Accordingly, those are the kinds of results usually offered for the solution of practical problems (IS).
Research: Online tutorial materials may help to guarantee the quality of data collection processes and mobile applications tailored to [Social Science Research] SSR methods may be useful to collect and share data in a secure way (CS).
Application: This perspective offers an approach to creating such systems by adapting scientific methods to the practical constraints of science communication. It focuses on contexts where the goal of science communication is helping people to make autonomous choices rather than promoting specific behaviors (CMS).
Research: Most importantly, in order to increase citizens' motivation to participate in SSR citizen science projects, it will be critical to increase awareness of SSR from early on. For that purpose, it might be helpful to implement SSR citizen science projects in a curriculum-based context (Bonney et al. 2015) (CS).
Research: Some common approaches in social science are easily achievable by citizen scientists (CS).
Research: This collaboration allows citizens to provide valuable feedback on research designs and to help disseminate research findings in their communities and beyond. This is an important step to improve the interaction between institutional SSR and society in practice and increase the legitimacy of scientific research in the context of new participatory demands (CS).
Integration: Looking forward, there are many emerging opportunities to use this and other validated tests to enhance adaptive decision support systems (i.e., custom-tailored risk communication) (Lipkus et al., 2010) (RL).
Integration: The creation of a fully developed theory usually gets created as a community effort through multiple iterations of research, development, and practice, and many times includes active participation of the industry (DSR).

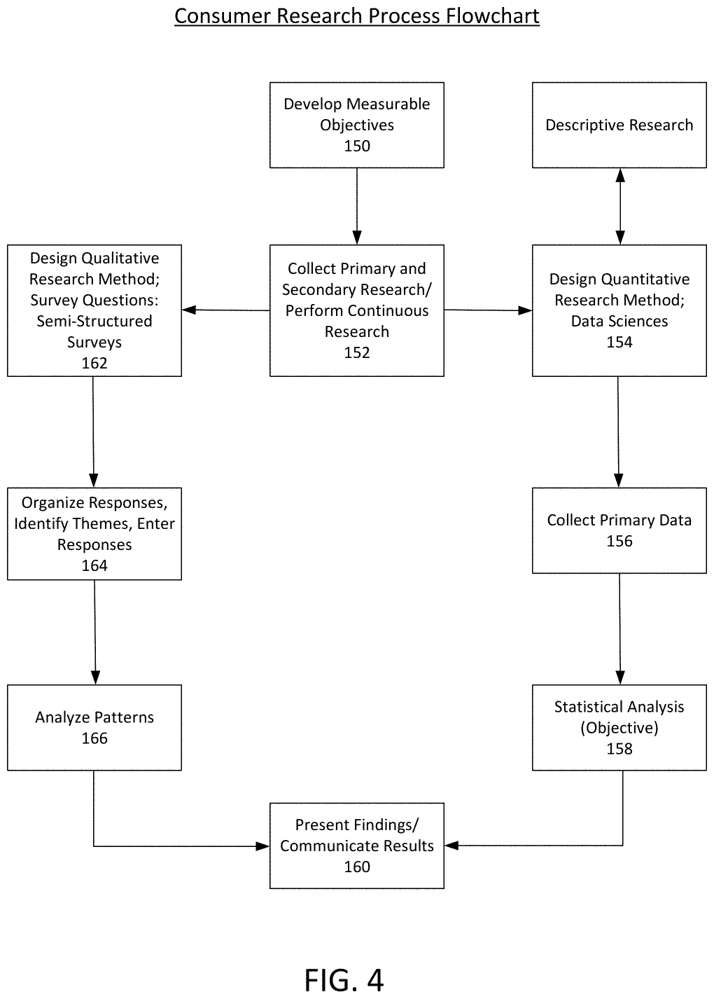

Also depicted in FIG. 1, the end-user operating system 102 involves the creation of data through the user interface where the data is collected, stored in a database, and then analyzed and/or aggregated. The data may be used to predict future responses and results. Erroneous data or data classifications may be individually analyzed. Specifically, the following teaching and discovery may be involved:
Teaching: In some cases, methods may be easily extended and adapted to citizen science, in which the participants [end-user/consumer] collects and analyzes their own data (CS).
Discovery: Personalized predictions at single subject level (specific single subject's estimations may be derived also when there are numerous predictors) and subjects which are classified erroneously may be individually analyzed to produce a more realistic estimate about the utility of a diagnostic procedure (ML).
   The data created and transferred using the end-user operating system 102 follows the critical thinking flowchart shown in FIG. 4.

As further depicted in FIG. 1, the scientist operating system 104 involves data discovery based on data gathered by the end-user operating system 102. The system may use the following research, discovery, application, and teaching tools:
Research: The impetus could be new research in reference disciplines on visual impacts on cognition and/or on decision-making (DSR).
Discovery: Cumulative effects of human activities on the environment are better understood at a regional scale, they can help make more strategic decisions for future development (CIA).
Discovery: The scientific method, as applied to social sciences, includes a variety of research approaches, tools, and techniques, for collecting and analyzing qualitative or quantitative data (SS).
Discovery: Descriptive Research is directed at making careful observations and detailed documentation. These observations must be based on the scientific method (i.e., must be replicable, precise, etc.) (SS).
Discovery: Explanatory Research seeks explanations of observed phenomena, problems, or behaviors (SS).
Discovery: To contribute knowledge by offering prescriptive statements and specification of outcomes for a system developed based on the theory (DSR).
Discovery: Recognize that the scientific method operates primarily at the empirical level of research, i.e., how to make observations and analyze these observations. Very little of this method is directly pertinent to the theoretical level (SS).
Discovery: Certainly, the self and community valuation of their efforts and findings is a highly significant motivator for any researcher. This path also provides a vehicle for not only showing how to design an artifact but also for understanding why the artifact should work (DSR).
Integration: Social science theories are rarely perfect, which provides numerous opportunities for researchers to improve those theories or build their own alternative theories (SS).
Integration: The development phase of a design science research effort can be an experimental proof of a method, an experimental exploration of a method, or both (DSR).
Application: Very little of the scientific method, as applied to social sciences is directly pertinent to the theoretical level, which is really the more challenging part of scientific research (SS).
Application: The practical objective is an influence on reality by offering solutions or theory needed for problems encountered in economy and administration (IS).
Application: The theoretical objective is to describe reality and thus extend the theoretical basis within the discipline (IS).
Application: Researchers develop solutions, which are handed over to practice (“informs”) (IS).
Application: Collaboration among experts from professional communities with different norms and practices. Those experts include scientists who know the subject matter and scientists who know how people communicate (CMS).
Teaching: Need to make decisions are disconnected: scientists typically focus cumulative effects research on the responses of ecological components to stressors, while decision-makers are interested in understanding the connection between human activities and stressors. There is a great need for improved baseline data and empirical evidence (CIA).
Discovery: The impetus could be new research in reference disciplines on visual impacts on cognition and/or on decision-making (DSR).

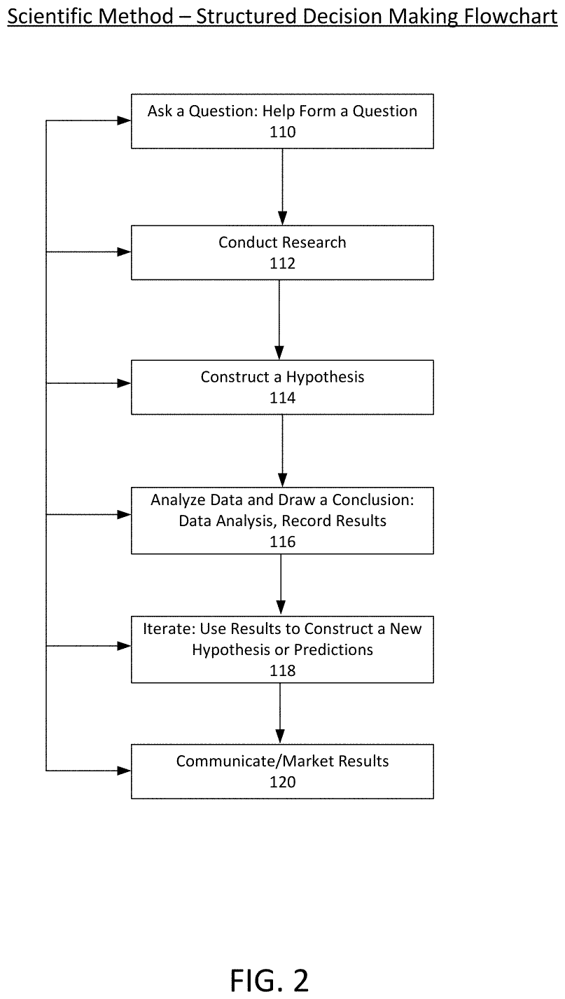

The observations and data analysis should be based on the scientific method (i.e., must be replicable, precise, etc.). The data collected from the scientist/researcher operating system 104 may allow the researchers/scientists/service providers to develop solutions for the consumer, including better financial solutions for targeted consumers, including those that may have been disadvantaged in the prior systems. The data created and transferred using the scientist/researcher operating system 104 follows the scientific method flowchart shown in FIG. 2.

The mixed-mode operating system 100 further involves additional creation-transfer processes that involve the consumer research process flowchart shown in FIG. 4. The system may include the following integration, discovery, and application tools:
Integration: Sometimes, joint use of qualitative and quantitative data may help generate unique insight into a complex social phenomenon that are not available from either type of data alone, and hence, that combine qualitative and quantitative data are often highly desirable (SS).
Discovery: Deep learning models used for cognitive theorizing emphasize the creative process and person: process, in emphasizing the role of cognitive mechanisms as a basis for creative thought; and person, in considering individual differences in such mechanisms (ML).
Application: The fusion of layer-type platform theory and interaction-type platform theory in platform products theory and development of social platform theory as two future directions for the development of platform theory (PT).
Application: Design-oriented BISER, addresses practical issues, contributing to the solution of such problems by creating innovative IT artifacts (Baskerville and Pries-Heje, 2010) (IS).
Application: Fusion of L-PF Theory and I-PF Theory in Platform Products Theory-Platform products and services have aspects of both the layer-type products and services in addition to that of being an interactive place. Based on the precondition that platform products and services have two aspects, the following can be envisaged as subjects for independent research relating to platform product theory in future. Regarding the layer aspect, the challenges of managing complementary products and services, such as product function strategies based on the precondition of complementary products and services or designing incentives for complementary players, could be the subject of research (PT).

Turning now to FIG. 2, shown therein is a Scientific Method flowchart used by the system 100.
A design science research (DSR) process generally includes six steps or activities (Peffers et al., 2007; Lapao et al., 2017; Teixeira et al., 2017): (1) identification of the problem, defining the research problem and justifying the value of a solution; (2) definition of objectives for a solution; (3) design and development of artefacts (constructs, models, methods, etc.); (4) demonstration by using the artefact to solve the problem; (5) evaluation of the solution, comparing the objectives and the actual observed results from the use of the artefact; and (6) communication of the problem, the artefact, its utility and effectiveness to other researches and practicing professionals. Peffers et al. (2007) states that research don't have to always start from the first step (i.e., identification) but mostly go through all of the steps in a way or another, moving outward from the point of entry of the research. Result of the DSR project is always a purposeful artefact which “can be a product or a process; it can be a technology, a tool, a methodology, a technique, a procedure, a combination of any of these, or any other means for achieving some purpose” (Venable and Baskerville, 2012, p. 142).
   “Design science research a short summary | by Rauno Pello . . . ” 31 Oct. 2018, https.//medium.com/@pello/design-science-research-a-summary-bb538a40f669.
Ultimately, as science develops a better understanding of cumulative impacts, standard approaches in risk assessment may need to change to assure the protection of public health. Environmental and social stressors clearly converge in disadvantaged communities, and tools to measure these impacts are needed for improved decision making. The use of cumulative impact methods increases the likelihood that disadvantaged neighborhoods may receive critical attention, improving existing conditions and reducing future harm.
   “Cumulative Environmental Impacts: Science . . . —Annual Reviews.” https://www.annualreviews.org/doi/10.1146/annurev-publhealth-032315-021807.

The scientific method flowchart utilizes a framework and particular steps, which allow for the cumulative impacts analysis (CIA) to be separated/independent, enabling the user to employ other decision-making tools or systems. The core elements of the scientific method flowchart are aligned with the benefits of structured decision making (SDM). SDM approaches are implemented in the framework. The CIA and SDM framework is built around insights from modelling systems and the decision sciences. The framework uses qualitative, quantitative, and statistical modelling approaches to understand and predict cumulative impacts on systems. These predictions are then used to inform a process of SDM. The framework allows for CIAs to be separated from the SDM process enabling the user to employ other decision-making tools or systems. An SDM process to engage actor(s), technical/specialized experts and decision-makers in a deliberative process.

In the scientific method flowchart of FIG. 2, at step 110 the process involves first asking a question. This step includes a framework structure of first defining a problem and set of objections and then specific framework steps including judgments around whether environmental or development scenarios present an acceptable risk to environmental values. The process of forming a question may be based on marketing and educational research questionnaires gathered in financial services and related subjects. Additionally, this step 110 may include conducting a systematic review of available literature. The purpose of a literature review is three-fold: (1) to survey the current state of knowledge in the area of inquiry, (2) to identify key authors, articles, theories, and findings in that area, and (3) to identify gaps in knowledge in that research area. The process utilizes Research Design, which is concerned with creating a blueprint of the activities to take to satisfactorily answer the research questions identified in the exploration phase.

Next, the process at step 112 conducts research/objectives for a solution. This can be used to provide guidance to public sector organizations. The framework structure of this step includes identifying options and alternatives for risk mitigation. The framework steps of step 112 step may include identifying management levers (conditions, strategies, and capabilities), and interventions to revisit review fundamental objectives as well as identification of activities responsible for risks. Identification and assessment levers minimize impacts and allows for evaluation of policies. This step 112 may include constructing psychometric factors and measurement for data collection and analysis. Specifically, consumers need to have stable representations of objects and events in memory that can be used for interpreting and evaluating objects and events in their environment. Strategies taught to consumers to break down frequency estimates into subcategories can reduce errors and processing effort (Menon 1997 Srivastava & Raghubir 2002) (CP). Research shows that information processing with respect to the self-increases elaborative thought and persuasion, such as when generating self-stories or when processing strong message arguments relative to the self (Burnkrant & Unnava 1995) (CP). Design Science research has been focused on basing their subject of research on findings from behavioral research, thus constantly establishing and defining their inquiries by means of the empirical works of KB (BS). Also, reference to theories is considered increasingly important as a way of improving the quality of artifacts when making decisions regarding design (IS). It has been shown that the most used Machine Learning evaluation metrics can be mapped into effect size. It is possible to transform the accuracy results obtained from ML models to more psychologically oriented effect size measures (ML).

Next, at step 114, the process constructs a hypothesis. The framework structure of this step involves describing the environment and identifying impacts (CIA). The framework steps include elements of a CIA, including stimuli response, summing up impacts, exposure pathways, multiple sources, stressors, and resilience. The framework steps further include methods to assess the directions of change in factors, activities, pressures, and/or values.

Analyses under this step studies characteristics of decision-makers, actors, and stakeholders such as demographics, psychographics, and behavioral variables, with the objective to find latent factors that create a commonality. Then, the process investigates the correlated variation among a set of observed variables in order to glean information from their underlying latent variables (factors/constructs). This step utilizes Business Platform Theory-A company that runs a model where, rather than offering a specific product, it enables the interactions between two or more players. The subject of discussion is shared platforms that are open to an unspecified number of complementary players (PT).

Various thesis in the field including Kokuryo and Platform Design Lab (2011) note the following five points as the key variables including (1) designing a platform using communication patterns; (2) designing roles; (3) designing Incentives; (4) designing a mechanism to develop psychological conditions that are necessary for enabling collaboration among people; and (5) management of the internal changes of participants. Visual elements and numerical information (Viswanathan & Childers 1996) have been found to convey meaning and influence these types of processes, such as information search, elaborative processing, attitudes, and consumption (CP). Design-oriented BISER, addresses practical issues, contributing to the solution of such problems by creating innovative IT artifacts (Baskerville and Pries-Heje, 2010) (IS). Experiments in psychological science has been traditionally analyzed with statistical inferential tools. However, recent controversies about the level of replicability in behavioral research of such analytical tools have cast interest in developing more efficient techniques for analyzing the results of psychological experiments (Pashler and Wagenmakers, 2012) (ML).

Next the process moves to step 116, which involves analyzing the data and drawing a conclusion and recording the results, evaluating artifacts, and applying evaluation methods. The framework structure for this step is to identify actions using decision analysis (social and economic outcomes) and may include analysis of alternatives, consequences, and tradeoffs. The framework steps of step 116 include identifying alternatives (representing scenarios and options) and analyzing consequences and tradeoffs are the end-points of the SDM process. Step 116 may include the design and development of multiple process model configurations. The model designed and developed may represent a system by defining relationships between collected variables (the data gathered). In practice, factor analysis is a data reduction technique that is used to statistically aggregate a large number of observed measures (items) into a smaller set of unobserved (latent) variables called factors based on their underlying bivariate correlation patterns (SS). This step may also include a mixed-mode design to combine qualitative and quantitative data (SS).

Step 116 creates new scientific insights, most importantly by gathering large-scale or hidden data, which researchers alone could not access by themselves (Raddick et al. 2010) (CS). The cooperation involved on this step should produce an educational outcome, such as increasing knowledge and scientific interest among participants (Land-Zandstra et al. 2015) (CS). Online tutorial materials may help to guarantee the quality of data collection processes and mobile applications tailored to social science research (“SSR”) methods may be useful to collect and share data in a secure way (CS). Design science research often focuses on examining the utility of an artifact (e.g., Hevner et. al, 2004), however it has been suggested that the evaluation of the artifact is evaluated for its fitness to adapt and survive within an environment or by considering the social impacts of the artifact (DeLeoz and Petter, 2018) (DSR). Thus, science communication's success might be evaluated by whether the step produced choices closer to the ones that fully informed decision makers would make (CMS).

Next the process at step 118 uses iteration to use the results to make new hypotheses and predictions of the data and propose a new methodology. The framework structure of this step involves assessing impacts and recommending actions based on qualitative and quantitative ecosystem models (e.g., make predictions, validate, and casual linkages). The Framework steps of step 118 include developing models to capture causal linkages between environmental drivers, human activities and to develop tools for highlighting key linkages between drivers, activities, impacts and effects on ecosystem values. This step 118 may include business process modeling (“BPM”), proof of concept implementation, comparison to current business methods and applications, and application to various use cases.

Under BPM, the known design science research methodology process model developed by Pefers, et al. (2008) attempts to synthesize selected prior literature on the topic by breaking the Awareness of Problem phase into two phases (DSR): (1) Identify Problem & Motivate, and (2) Define Objectives of a Solution. This step also merges the suggestion and development phases into a single phase—Design & Development. It then breaks the evaluation phase into two phases: (1) Demonstration, and (2) Evaluation. A distinguishing feature of this model is identification of the fact that the design science research process can be initiated from a variety of contexts—Problem-Centered Initiation, Objective Centered Solution, Design & Development Centered Initiation, Client/Context Initiation—and start in a corresponding phase of the nominal process sequence shown (DSR).

Under proof-of-concept implementation, design science research can contribute to better theories (or theory building). The methodological construction of an artifact is an object of theorizing for many communities (e.g., how to build more maintainable software), the development phase of a design science research effort can be an experimental proof of a method, an experimental exploration of a method, or both (DSR). Next, the method may be compared to current business applications. The research is motivated by common problem awareness: that a better interface needs to be developed that will allow users to more quickly and effectively obtain answers to questions about the performance of their business operations (DSR).

Also, step 118 can be used for application to various use cases. This collaboration allows citizens to provide valuable feedback on research designs and to help disseminate research findings in their communities and beyond (CS). The creation of a fully developed theory, however, cannot be expected from a single design science research project. It usually gets created as a community effort through multiple iterations of research, development, and practice, and many times includes active participation of the industry (DSR).

The advantage of basing the construction of IT artifacts on theory is that the amount of iteration passed during construction can be decreased. Also, it has been stressed during the past years that theories from DS research represent important output of DS research (Nunamaker et al. 1991; Walls et al., 1992). Those design theories can then refine the theories of behavioral research (Kuechler and Vaishnavi, 2008) (IS). We claim that the use of ML could be a useful complement to inferential statistics and will help in achieving at least the following objectives: (1) developing models which can generalize/replicate to fresh new data; and (2) developing models focused on prediction also at single subject level (ML).

The process then moves to step 120 wherein the process communicates/markets the results of the process to decision makers, such as scientists, researchers, educators, policy makers, and service providers. The framework structure of step 120 involves reporting the results of CIA to encourage structured decision-making processes (informed solutions) and including policies, toolkits and management decisions. The framework steps of step 120 involve protection of ecosystem values as a key fundamental objective, communication of results to decision-makers, and implementation of programs that test and monitor the effectiveness of decisions to enable an adaptive management approach.

In step 120, the communication and marketing of the results is achieved and obtained by communication and commercialization of the data within an integrated platform business process modeling software (“BPMS”) within the system. This step includes collecting innovative, large-scale data, which may solve important scientific and social questions (SSR). This may include a method where the participants collect or analyze their own data (CS). The process may implement SSR citizen science projects in a curriculum-based context (Bonney et al. 2015) (CS). A sufficient pool of potential participants and the successful mobilization of this group is a key prerequisite for the successful implementation of a citizen science project (CS). The cooperation with users and consumers will allow access to largescale and “hidden” data which are collected and provide an innovative potential for the knowledge production in SSR. This step also contributes to create large databases by collecting and categorizing otherwise inaccessible social media content or may implement large-scale interviews with multiple target groups, which researchers could not reach on their own (CS).

Effective science communication requires assembling scientists with knowledge relevant to decision makers, translating that knowledge into useful terms, establishing trusted two-way communication channels, evaluating the process, and refining it as needed. This perspective offers an approach to creating such systems by adapting scientific methods to the practical constraints of science communication. It focuses on contexts where the goal of science communication is helping people to make autonomous choices rather than promoting specific behaviors (CMS).

Recent applications of ML and deep learning methods in psychological science are emerging mainly outside the academic arena. However, the number of experiments reported in academic journals that use ML as analytical tools to complement statistical analysis is also increasing (Kosinski et al., 2013; Monaro et al., 2018; Pace et al., 2019) (ML).

Step 120 may also include a proof-of-concept implementation, which utilizes design science research to contribute to better theories (or theory building) which may utilize the methodological construction of an artifact as an object of theorizing for many communities (e.g., how to build more maintainable software), the development phase of a design science research effort may be an experimental proof of a method, an experimental exploration of a method, or both. The process can also compare the research to current business applications. The research may be motivated by common problem awareness, e.g., that a better interface needs to be developed that will allow users to more quickly and effectively obtain answers to questions about the performance of their business operations.

The scientific method may also apply the results obtained from the data to various use cases. This collaboration allows users or consumer to provide valuable feedback on research designs and to help disseminate research findings in their communities and beyond. The creation of a fully developed theory, however, cannot be expected from a single design science research project. It usually gets created as a community effort through multiple iterations of research, development, and practice, and many times includes active participation of the industry, which is inherent in the proposed method and system. It will be understood that although the scientific method flowchart of FIG. 2 shows the steps in a particular order, these steps are iterative and circular and can be performed in a variety of ways. The purpose is to continue to build the data set and the qualitative and quantitative research done on the data to continue to provide additional feedback to those using the data, including the consumers themselves.

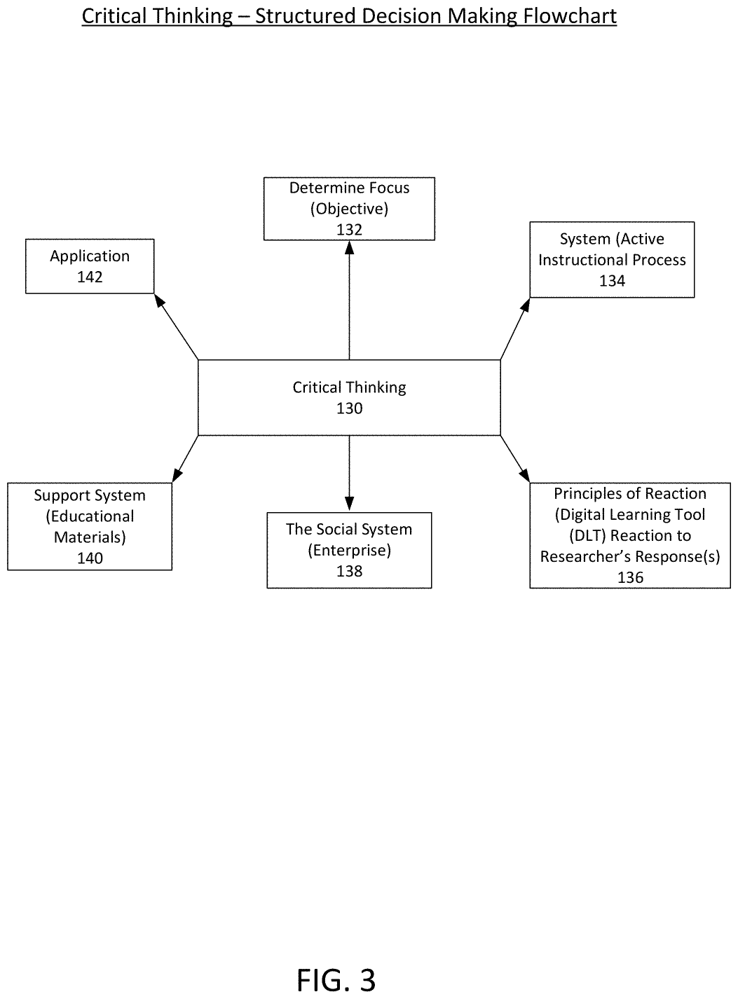

Turning to FIG. 3, the method and system include a critical thinking toolkit 130. “Critical Thinking is an important requirement for individuals to make better decisions, while various decision-making techniques also contribute positively to the quality of critical thing of individuals” (CT)(CTQ). The Focus 132 of the system and method is to improve literacy and critical thinking in the consumer decision-making process to foster the development of intellectual traits or dispositions/virtues. Numeracy has been shown to predict more elaborate and heuristic searches (e.g., transforming probabilities, comparing relative magnitudes, and considering the time required to earn equivalent sums of money).

Focus 132 may involve problem identification and analysis (a CT component) and continuing education using structured analytics (CT outcome). Focus involves an approach to identifying and evaluating alternatives that focuses on engaging stakeholders/actors, experts and decision makers in productive decision-oriented analysis (SDM). It is also a decision-focused roadmap for integrating activities related to planning, analysis, and consultation (SDM). Further, Focus allows the system to learn how decisions should be made with the realities of how decisions are made and defines what (Intelligence) question or problem is being addressed and why, identifying actor(s) involvement, establishing the scope and boundaries for decisions (SDM)

Focus is also used to improve literacy and critical thinking in the consumer decision-making process. The ultimate goal of Critical Thinking is to foster the development of intellectual traits or dispositions/virtues (CT). Numeracy was shown to predict more elaborative encoding and heuristic search (e.g., transforming probabilities, comparing relative magnitudes, and considering the time required to earn equivalent sums of money) (RL). When critical thinking is applied to decision-making, it raises the decision-making model to a level of conscious and deliberate choice and increases the susceptibility of decisions to reason and logic (Paul & Elder, 2014, p. 183) (CTQ).

Additionally, the system utilizes an Active Instructional Process 132 to classify consumers by applying demographic facts and continuous accumulation of data. The goal is to develop a systematic way of questioning and increase active and disciplined questioners within each subject of analysis. The Active Instructional Process involves clarification of meaning (CT component) and establishes policies and a toolkit of analytic and problem-solving methods (CT outcome). This process provides a series of steps and structuring tools based on the principles and practices of decision analysis (SDM). It also includes a set of objectives and evaluation criteria and a framework for comparing alternatives (SDM). This process classifies consumers by applying demographic factors and continuous accumulation of data using the following additional steps:
Step 1—Consumer Group educational analysis and development of business case analysis.
Step 2—Demographic Group(s) presentation of business case analysis.
Step 3—Socratic questioning/analysis.
Step 4—Distribution of Informational Text using psychometric scale(s) in various formats on the system.
Step 5—Online Socratic interview using the system.
   “[Students of the system] must learn a systematic way of questioning. Thus, to understand and think within any subject, students must become active and disciplined questioners within the subject” (CT). These statistical aspects of numeracy are key features of risk assessment in business and engineering (Ayyub, 2003; Covello & Mumpower, 1985; Froot, Scharfstein, & Stein, 1993) (RL).

The Critical Thinking process also reviews Principles of Reaction 136 utilizing a digital learning tool (“DLT”) which reacts to researcher's responses. Various decision techniques are used in decision-making to help to improve the quality of critical thinking. The principles of reaction 136 involves gathering and assessing the evidence (CT component) and using critical thinking techniques to structure analytic reasoning (CT outcome). Under Principals of Reaction, innovative policies and management alternatives are designed to address the objectives. Alternative approaches to the problems or objectives should present decision makers with real options and choices (SDM). A dialogic communication between consumers in collaborative problem-solving groups (demographic factors), probing consumers to think through questions. Impartiality is established while maintaining the dialectic style and showing significance to ask questions and/or answer to improve the consumers knowledge. Critical thinking provides the tools for assessing information (CT). Statistical numeracy has been shown to be a predictor of decision strategies, affective reactions, comprehension, and normative choices across many risky economic, health, and consumer decisions (Banks, O'Dea, & Oldfield, 2010; Cokely & Kelley, 2009; Lipkus & Peters, 2009; Peters & Levin, 2008; Peters et al., 2006; Reyna et al., 2009) (RL).

The Critical Thinking process uses a Social System 138. The Social System (Enterprise) involves components/elements of critical thinking (problem identification and analysis, problem clarification, gathering and assessing evidence, inferences, factors, casual linkages, decision) and then infers conclusions (CT component). The Social System also applies and combines critical thinking and multiple methods of structured analysis against an intelligence question (CT outcome). The Social System 138 uses filters of logic and reason conduct an exercise in which the performance of each alternative is estimated in terms of the evaluation criteria developed (SDM). The Social System 138 may involve a Digital Learning Tool (“DLT”), which may be capable of beginning the task and then allowing consumers to take over. There is collaborative structure between the Socratic DLT and researcher (consumer). The model is learner-centered as the Socratic DLT will act as a guide, continuously giving feedback. Preparations consist of a demographic factors business case analysis, case presentation, and Socratic discussion in Social-Media.

Under Social System 138, CT provides tools for both internalizing content (taking ownership of content) and assessing the quality of that internalization. It enables us to construct the system (that underlies the content) in our minds, to internalize it, and to use it reasoning through actual problems and issues (CT). It can be understood that even reasonable people cannot think critically at times due to impulses, pressures, tendencies, and distractions (Rudinow & Barry, 2008, p. 15). In order to improve the quality of executive decisions, it would be appropriate to find and eliminate the real causes of these barriers (CTQ). As a result, it can be said that innovative thinking is based on the evaluation aspect of critical thinking and critical thinking is based on the open-minded and flexible aspects of innovative thinking (Ozgenel, 2018) (CTQ).

The Critical Thinking process also uses a Support System 140, which includes educational materials with creative formats and strategies of informational text to teach and inform consumers about existing business issues in their strategies utilizing Socratic questioning and answering process. The Support System 140 considers other relevant information (CT component) and may be used to define an intelligence question and analyze intelligence associated data, information and evidence (CT outcome).

In the Support System 140, consultations contribute a fundamental role in evaluating preferences for alternatives. preference assessment methods may be used to help people understand their preferred alternatives (SDM). Consultations also may be used to provide awareness to decision makers about how well their objectives may be fulfilled by potential alternative courses of action (SDM). The educational materials provided may include creative formats and strategies of informational text to teach and inform consumers about existing business issues in Consumers Decision Making strategies using the Socratic questioning and answering process. Standards involved in the Support System include outcome measures useful for teacher assessment, self-assessment, as well as accreditation documentation (CT). Psychometric Factors-individual differences in statistical numeracy and risk literacy result from the complex interaction of many including one's (1) intuitive number sense; (2) gist v. verbatim representations; (3) reflective and elaborative encoding; and (4) skilled understanding of mathematical operations. Moreover, there are likely many other important factors to consider.

The Support System 140 may also include Measurements Information Literacy—Measurements Information Literacy-Statistical numeracy tests that provide larger item pools and parallel forms that can be administered to the same participants multiple times without inflating test scores (e.g., limiting item familiarity effects). This option for repeated measurement is necessary for the assessment of developmental changes associated with skill acquisition.

Finally, the Critical Thinking process of the system includes Application 142 of the tools to what consumers research and learn within the system by studying the characteristics of consumers including demographics, psychographics, and behavioral variables, with the objective to find latent factors that create a commonality, which data can be used to estimate the percentages of groups in various categories. The Application 142 includes an overall judgment (CT component) and may combine methods using policies and a toolkit into an effective analytic strategy (CT outcome).

Under Application 142, it may be possible to identify mechanisms for continuous monitoring to ensure accountability with respect to on-ground results, research to improve the information base for future decisions, and a review mechanism so that new information can be incorporated into future decisions (SDM).

Application is also used for decisions involving the technical analysis with value-based deliberations. Value-Creation System (SDM). Additionally, the system may apply what the consumers are researching and learning on the system studying characteristics of consumers such as demographics, psychographics, and behavioral variables, with the objective to find latent factors that create a commonality. This information can be used to estimate the percentages of groups in various categories. The key to the creative side of Critical Thinking (the actual improving of thought) is in restructuring thinking as a result of analyzing and effectively assessing it (CT). Application 142 also may play central roles in health risk quantification and communication (Lipkus & Peters, 2009; see also Gigerenzer, Gaissmaier, Kurz-Milcke, Schwartz, Woloshin, 2007) (RL).

Application allows the system to use methods that provide details about the ecological frequencies of problematic risky decisions, including those related to risk literacy, using techniques such as representative sampling (Dhami, Hertwig, & Hoffrage, 2004) (RL). This type of epidemiological data could then be used to start to quantify the relative economic, personal, and social impact of specific weaknesses in numeracy and risk literacy (e.g., when and how often does denominator neglect affect high-stakes vs. lower stakes risky decisions among less numerate individuals; for a related discussion see Garcia-Retamero, Okan, & Cokely, in press) (RL). Thus, Application 142 applies and combines critical thinking and multiple methods of structured analysis against an intelligence question.

Turning to FIG. 4, shown therein is the Consumer Research Process of the system and method. This process involves collecting innovative, large-scale data, which may solve important scientific and social questions and a method in which the participants collect or analyze their own data (CS). The process may also include interpretive methods which employ an inductive approach that starts with data and tries to derive a theory about the phenomenon of interest from the observed data. (SS) Effective science communication requires:
Assembling scientists with knowledge relevant to decision makers.
Translating that knowledge into useful terms.
Establishing trusted two-way communication channels.
Evaluating the process, and refining it as needed.
   (CMS). This perspective offers an approach to creating such systems by adapting scientific methods to the practical constraints of science communication. It focuses on contexts where the goal of science communication is helping people to make autonomous choices. (CMS) Communicating science effectively can require an unnatural act: collaboration among experts from professional communities with different norms and practices. Those experts include scientists who know the subject matter and scientists who know how people communicate. (CMS)

As further depicted in FIG. 4, the process includes step 150 wherein the system develops measurable objectives. The process then moves to step 152 and the collection of primary and secondary research which includes ongoing and continuous research. The process then branches and in one step 154 conducts a design of quantitative research method utilizing data sciences and utilizes descriptive research on an ongoing basis. Next, the process at step 156 collects primary data and then at step 158 it performs a statistical analysis of the data using objective data. The process then presents the findings of the process and research through communication of those results at step 160. In another aspect, after collecting primary and secondary research at step 152, the process moves to step 162 and designs a qualitative research method by utilizing survey questions and semi-structured surveys. It then moves to step 164 and organizes the responses from the surveys, identifies themes, and enters those responses into the system database. The process at step 166 analyzes patterns in the responses and data gathered and then moves to step 160 to present the findings and research results.

The system and method can then communicate the findings and results to the user. The results page will develop a process of knowledge and curricula between the user(s) and provider(s) matching criteria to help make informed decisions. A provider list will be based on the user's community and geographic boundary location and responses to additional questions. Matching providers will receive the user's information.

The process may in some embodiments include a design for Six Sigma Methodology and the means disclosed herein consisting of the below-listed steps:
Define—(CBIS)—A Reciprocal Teaching and Learning Communications tool that supports decision-making, co-ordination and control as well as visualization and analysis in Consumer Financial Services. Identifying relational information wants and needs most important to both consumers and lenders by established metrics in Information Sciences and Technologies (concepts and methods), Data Analysis, Client Feedback, Statistics, and other information sources for continuous development.
Measure—Research and Development Data by licensed professionals in each category: Financial Services and Education; Marketing Strategies and Statistics; Digital Scientific Analysis Technology; Product Evaluation. Incorporated the DS (Design Science) Process to create and evaluate new properties in financial, technical, cognitive, social, and informational resources.
Analyze—Utilizing data provided by each professional organization the final processes was designed internally for assessment and measured improvements as needed for the customers and lenders aligned goals.
Design—The Design Science Research Methodology (DSRM) presented incorporates principles, practices, and procedures required to carry out such research and meets objectives: it is consistent with prior literature, it provides an economical process model for doing Design Research (DS), and it provides a mental model for presenting and evaluating DS research in Information Systems (IS). The process includes problem identification and motivation, objectives for a solution, design and development, demonstration, evaluation, and communication producing an innovative product.
Verify—With customer (consumers and lenders) reviews and feedback coming in, developments are made through a continuous improvement process linked back to the products goals and priorities leading to new applications in subsequent areas.

In the creation of the process, each element of the Design for Six Sigma (DFSS) DMADV Methodology is necessary.

Additional Lean Management/Techniques Design for Six Sigma and traditional Six Sigma are two concepts which share similar methodologies and tools which can be implemented to re-engineer the business process including, but not limited to:
DMAIC—Define, Measure, Analyze, Improve, Control.
IDOV—Identify, Design, Optimize, Verify.
IDDOV—Identify, Define, Design, Optimize, Verify.
DDICA—Design, Develop, Initialize, Control, Allocate.
DMADOV—Define, Measure, Analyze, Design, Optimize, Verify.

Additionally, the process consists of Technologies in Educational and Teaching; Marketing Strategies; Computer, Information, and Social Sciences; Data Sciences; Financial Services; Communal Services. This process can be commercialized in the Tertiary and Quaternary Industry's/Sectors including, but not limited to:
Financials: The financial sector consists of banks, investment funds, insurance companies and real estate firms, among others.
Utilities: The utilities sector consists of electric, gas and water companies as well as integrated providers.
Consumer Discretionary: The consumer discretionary sector consists of retailers, media companies, consumer service providers, apparel companies and consumer durables.
Industrials: The industrial sector consists of aerospace, defense, machinery, construction, fabrication and manufacturing companies.
Technology: The technology sector consists of electronics manufacturers, software developers and information technology firms.
Telecom: The telecom sector consists of wireless providers, cable companies, internet service providers and satellite companies, among others.

The system and computer-implemented method disclosed herein may include a database programed to perform database driven analytics using data sciences from various categories and professions (psychometrics, personality theories, marketing, product management, operations research, and finance) to study characteristics of consumers such as demographics, psychographics and behavioral variables and find latent factors that create a commonality. This information may then be processed to estimate the statistical data of groups in various categories exhibiting certain behaviors to determine the customers' expectations related to the products being offered, including:
database infrastructure and processing;
scripting languages: Python, etc.;
statistical computation: R, etc.;
machine learning;
experimental design;
Bayesian inferencing;
data visualization;
data storytelling;
data psychology.

The database processes information received from users of the website to continually learn and analyze commonalities to require less human intervention based on how the users handle exceptions and responses to the information presented. Data that forms the basis of the day-to-day operations and management of the business having different characteristics, requiring integration and reconciliation before use in tracking performance, identifying problems, and setting directions to provide to the users. The process utilizes the collected and observed data and supplements it with prior and predicted data to drive the results, compiling the results by a collection of data from diverse sources on the user interface and website, including psychometric tests (i.e. probing questions). The data is then processed to be used on the user interface of the website.

The information listed below presents an accumulation and analysis of psychometric factors and measurements tools, such as creative formats and strategies of informational text and inputs throughout the website or user interface, which are stored in one or more databases, and processed by the system to create a consumer behavioral model (decision-making strategies) based on continuous and up-to-date real time data. The psychometric factors and measurements are specified for use in the web-based information system and database to be communicated between consumers and the business, such as financial organizations:

The system may use a process of applying various methods of input and processes on the website to gather and interpret the data received from a user, these methods may include the following:
Literary Nonfiction-literary nonfiction includes shorter texts, such as personal essays, speeches, opinion pieces, essays about art or literature, biographies, memoirs, journalism, and historical, scientific, technical, or economic accounts (including digital sources) written for a broad audience, communicating factual information. Autobiographies, biographies, other narrative nonfiction, informational picture books, and informational poetry often fit into this category.
Expository Text-fact based with the purpose of exposing the truth through a reliable source (trade books, articles, reports, textbooks, interviews, and essays). Contain tables of contents, indexes, or other navigational devices so that readers may read only the portions that interest them. Expository texts utilize various text structures, such as description, cause and effect, comparison and contrast, problem and solution, question and answer, and temporal sequence. True and deliberate Expository Text will focus on educating its reader.
Argument or Persuasion Texts-provide evidence with the intent of influencing the beliefs or actions of the target audience. These texts typically include claims, evidence, and warrants to explain how the evidence is linked to the claims. Writers of persuasion or argument also make appeals-appeals to the author's credibility, to the audience's needs, or to reason and evidence.
Procedural Texts-provide step-by-step information or directions so that people can successfully perform activities in safe, efficient and appropriate ways. They often include a materials-needed section and graphics that illustrate the process. Directions, Instructions, Rules for Games, Recipes, Manuals, Agendas and Science Experiments are common examples of procedural texts.
Natural Observation—Natural Observation by using Socratic Games as a teaching method. Engage in a thinking process that will expand their understanding and therefore, their ability to play the game. Applying “What is” questions and answering each question in the form of a definition. This process of questioning and answering would continue until the fundamental questions on the subject area had been discovered and answered, where the consumer(s) gain a good understanding of the subject, stimulating Critical Thinking. To challenge accuracy and completeness of thinking in a way that acts to move consumers towards their ultimate goal
Case Studies—Obtaining detailed information about an individual to develop general principles about behavior.
Surveys/Probing Questions—The technique of gathering data by asking questions to people who are thought to have desired information.
Correlation Design—Understand what kind of relationships naturally occurring variables have with one another.
Experimental Methods—A study in which the investigator manipulates (at least) one variable while measuring (at least) one other variable. This method relies on controlled methods, random assignment and the manipulation of variables to test a hypothesis.
Personality analysis of the following five factors and one additional factor:
   Openness to Experience (Inventive Curious vs. Consistent Cautious). Willing to try new things vs. Pragmatic and data driven. Transformational.
   Conscientiousness (Efficient Organized vs. Easy-Going Careless). The average level of conscientiousness rises among young adults and then declines among older adults. Transformational.
   Extraversion (Outgoing/Energetic vs. Solitary Reserved). Generally, people are a combination of extraversion and introversion. Transformational.
   Agreeableness (Friendly Compassionate vs. Challenging/Detached). Agreeableness is a social trait. Possible-Transformational.
   Neuroticism (Sensitive Nervous vs. Secure Confident). Less Transformational.
   Honesty-Humility (Sincere Faithful vs. Deceitful Greedy).
Normative Measurement—presents one statement at a time to a user to allow a respondent to use a five-point Likert-type scale to indicate the level of agreement they feel with the statement: from strongly disagree, disagree, neutral, agree and strongly agree.
Time-Use Survey—presents a statistical survey which aims to report data on how on average, people spend their time.
Satisfaction with Life-create/develop a revised Scale based on financial objectives and creatively integrate into website. Below are the statements used to determine an individual's satisfaction on the Satisfaction with Life Scale (SWLS). Use this as a model.
   In most ways my life is close to my ideal.
   The conditions of my life are excellent.
   I am satisfied with my life.
   So far, I have gotten the important things I want in life.
   If I could live my life over, I would change almost nothing.
Self-efficacy—The construct of perceived self-efficacy reflects an optimistic self-belief. This is the belief that one can perform a novel or difficult task, or cope with adversity—in various domains of human functioning. Perceived self-efficacy facilitates goal setting, effort investment, persistence in face of barriers and recovery from setbacks. It can be regarded as a positive resistance resource factor. (When I am confronted with a problem, I can usually find several solutions).
   “What kind of feedback did you get?”
   “How did that make you feel?”
   “What was the financial impact?”
   “Looking back, what would you do differently now, if anything?”
   What are you thinking about when you hear that question? Think Aloud
   What does that word or phrase mean to you? Probing
   What are most important factors in trusting a lender? Probing
Achievement Motivation-Typically self-motivated and process-oriented. The need for success or the attainment of excellence. Achievement-related attitudes include task-involvement—a task-involvement activity more often results in challenging attributions and increasing effort (typically in activities providing an opportunity to learn and develop competence) and will seek information relevant to attaining their goal of improving mastery in task-involving conditions. Some people strive to achieve their goals for personal satisfaction and self-improvement (Intrinsic Motivation), while others compete with their surroundings in achievement settings to simply be classified as the best (Extrinsic Motivation). (Structure the data analysis to address these “conditions/differences”).
Grit (Perseverance/Persistence)—Grit is functionally a measure of conscientiousness. Conscientiousness is seen as having six facets:
   Competence
   Order
   Dutifulness
   Achievement Striving
   Self-Discipline
   Deliberation
Cognitive Reflection-Decision Making and/or Behavioral Decision Theory (Normative)—The Cognitive Reflective Test (CRT), using Heuristics (Intuition/best guess/common sense) strategies to form judgments and make decisions and Normative Decision Theory, which analyzes the outcomes of decisions.
Crystallized Intelligence-Quick thinking and the ability to reason. Crystallized Intelligence refers to the accumulation of knowledge, facts, and skills that are acquired throughout life. Crystallized Intelligence continues to increase throughout adulthood and can be improved through learning.
Fluid Intelligence—Fluid intelligence refers to the ability to reason, think flexibly and solve problems. Fluid intelligence begins to decrease after adolescence (late adulthood). It is possible to improve fluid intelligence with brain training. Fluid and Crystallized Intelligence are intertwined. Crystallized intelligence is formed through the investment of Fluid Intelligence when information is learned. By using Fluid Intelligence to reason and think about problems, the information can then be transferred to long-term memory so that it can become part of Crystallized Intelligence. Improving Intelligence-Working memory is a form of short-term memory centered on what you are currently thinking about, its important because it involves not only being able to store information for a brief period of time but also the ability to mentally manipulate that information, therefore training a person on a specific working memory task would improve performance on that specific task. Training also increased unrelated cognitive skills, including the ability to reason and solve new problems totally independent of previously acquired knowledge, in essence a person may be able to engage the abstraction of thoughts and ideas as readily as applying knowledge-based reasoning.
Implicit Theories of Intelligence-Use the Incremental Theory of Intelligence mindset which proposes that intelligence and ability are malleable traits which can be improved upon through effort and hard work. There is a perceived possibility of mastery even when initial ability to perform a task is low. This possibility of mastery contributes in part to intrinsic motivation of individuals to perform a task, since there is perceived potential for success in the task. Problems can be corrected through effort, leading incrementalistic individuals to continually seek any situation that will intellectually better themselves. Individuals with an incremental mindset will take feedback and channel that into determination to try new strategies for solving a given problem and are more effective at self-regulated learning, ultimately leading them to be more productive at developing plans for learning. Incremental individuals generally have positive and stable self-esteem. Task involvement goals involve individuals aiming to improve their own abilities. Individuals who believe they have the ability to grow and add to their knowledge gladly accept challenges that can aid in growth towards mastery. Individuals who believe their abilities are fixed will also accept and persist through challenges as long as they feel they will succeed and their abilities will not be questioned. Incrementalistic individuals tend to have stronger negotiating skills, believing that with effort a better deal can be reached. This finding may have implications for more favorable working conditions for those with incrementalistic beliefs.
Understanding Everyday Risks (Risk Preferences)—A general factor of individual risk preference, which remains stable over time. Importantly, that factor cannot be assessed by conventional behavioral tests, which often yield contradictory results. What is the nature of the risk preference driving risk-related decisions? Does people's willingness to take risk depend on the context or is it largely consistent across situations? According to findings from the large-scale Basel-Berlin Risk Study, both are correct. Findings indicate that risk-taking propensity has a psychometric structure similar to that of psychological personality characteristics. Like the general factor of intelligence, there is also a general factor of risk preference. But our finding of a general factor of risk preference-based on self-reports and frequency measures of actual risky activities-suggests that risk preference is a personality characteristic in its own right. This insight will make it possible to examine the biological underpinnings of risk preference in future studies Specifically:
   They collected self-reports of risk-taking propensity in hypothetical scenarios.
   Ran experimental behavioral tests involving financial incentives.
   Asked participants about their actual risky activities in everyday life.
Satisficing vs Optimal Decision Making-Satisficing is a decision-making strategy or cognitive heuristic that entails searching through the available alternatives until an acceptability threshold is met. Optimal Decision Making is concerned with finding the best solution available and is more resource intensive. When making decisions using satisficing, the first decision that achieves the desired outcome may be picked despite the potential drawbacks. When trying to make an optimal decision, the decision-making process would be continued in order to mitigate the drawbacks. Lack of information decreases optimization.

As illustrated in FIGS. 5-8, the user frontend may be a graphic user interface (GUI) capable of cumulative impact analysis. The user frontend may be capable of asking the consumer for the type of financial assistance needed, and the system may provide the user a preview of the number of providers in their area. Each provider has specific qualifications needed for a loan application, so each will be consulted using the financial service provider backend as they sign up to ensure the user form addresses any required questions. The information displayed to the user and implemented by the service provider will act as a guide, so that when the user or service provider provides particular information, the system can analyze the data that has been processed and stored and then focus on critical thinking and provide targeted results to the consumer. If the user would like to see additional provider information, they can submit this information to the system. This ensures the system obtains the users information and data to be applied for educational and marketing strategy development. This also establishes a portal between the consumer and provider for information analysis and marketing strategies to the data analytics middleware.

The user frontend can be set up to request information in the form of cooperative dialogue and filtered questions between parties. Users can fill out a short form to determine their specific needs and see which providers in the system matches those needs. From there they will have the ability to self-select or have the system choose for them based on asking and answering questions. Educational questions can be added based on the providers instructive feedback and needs of participating provider(s). The system will let the user know and give them the ability to opt-in by going to the 2nd form step.

FIG. 5 is focused on marketing and connectivity. “Providers know very little about cash-based customers. This is because cash transactions leave no digital record” (FI). Further, what is needed is “connectivity that enables customers to communicate with the provider's transaction system through a digital interface” (FI). The goal is to “Provide[s] additional clarity around the roles and requirements for the various participants” (OML).

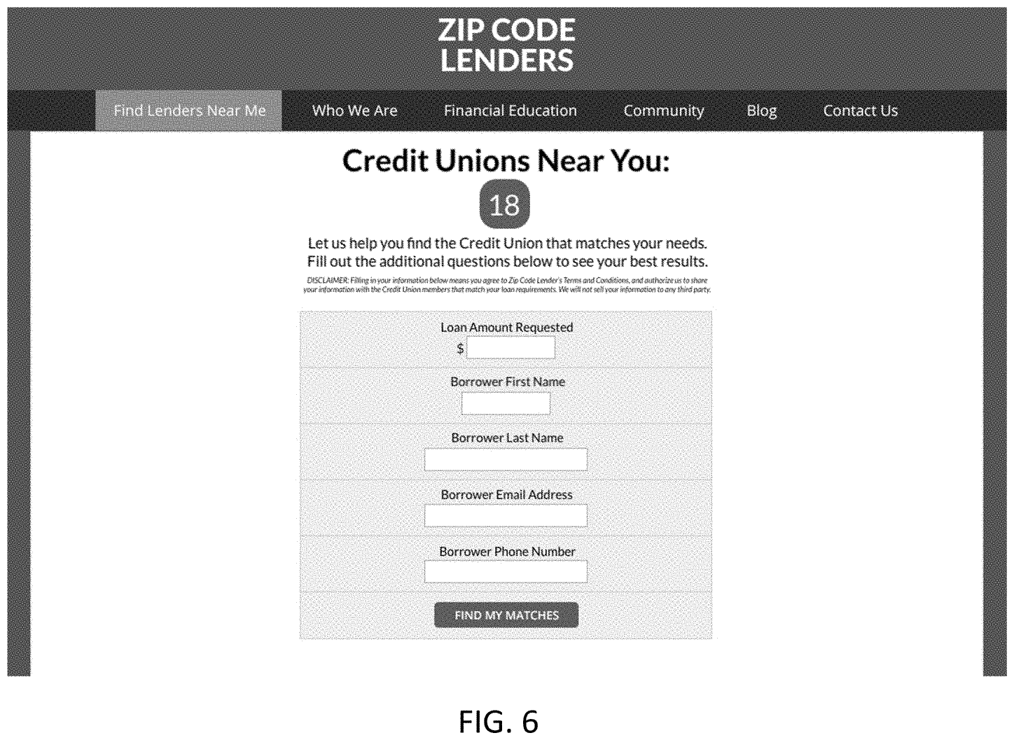

FIG. 6 is focused on matches/connectivity/leads for the consumer. The goal is to provide the consumer with “[m]ultiple interconnected platforms that enable customers to transact with any chosen counterpart, regardless of their payment provider” (FI). Connectivity includes “[a] virtual account that enables digital payment connectivity” (FI). The system may be used to “broaden existing business practices and expand access to credit for borrowers.” (OML).

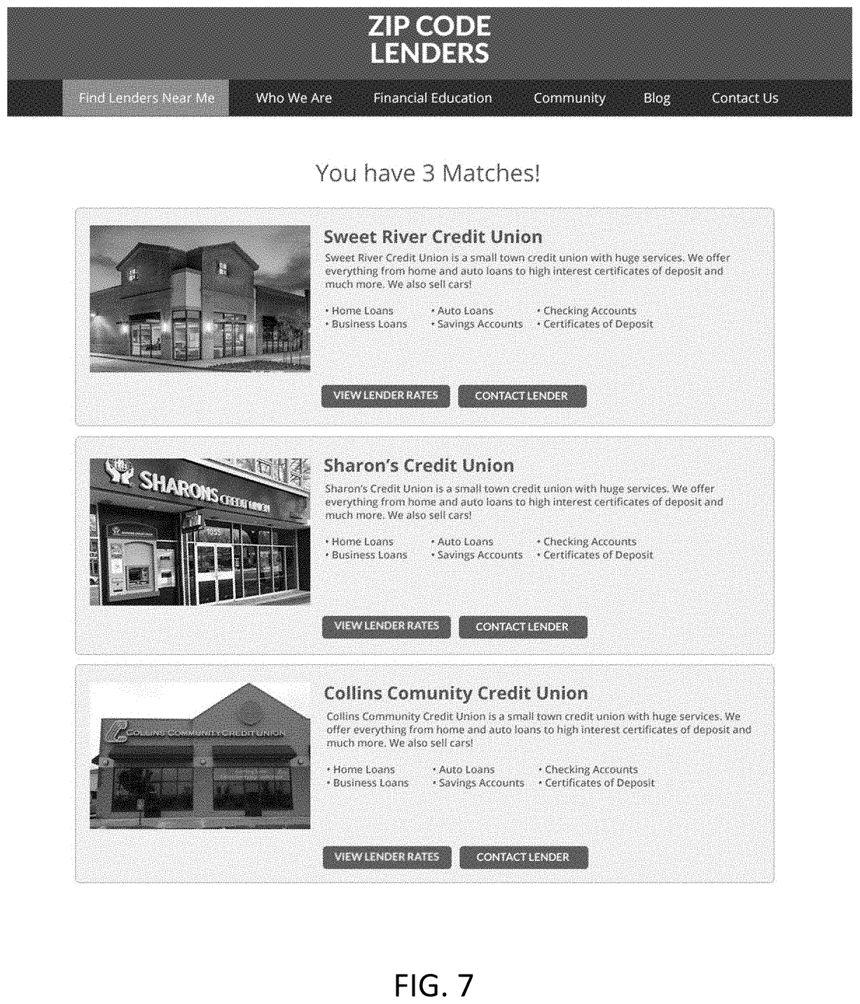

FIG. 7 is focused on matching the customer and service provider with choices and options. The system may be used to serve users and accommodate a range of customers (FI). It may also enable customers to convert their physical cash into digital money (and vice versa) (FI). Additionally, the system may allow providers to offer new products, improve borrower/consumer experiences, or reach new customers. (OML). Finally, the system may allow digital remote payments, digital in-store purchases, digital savings, credit, and insurance services, transact digitally with formal institutions (FI).

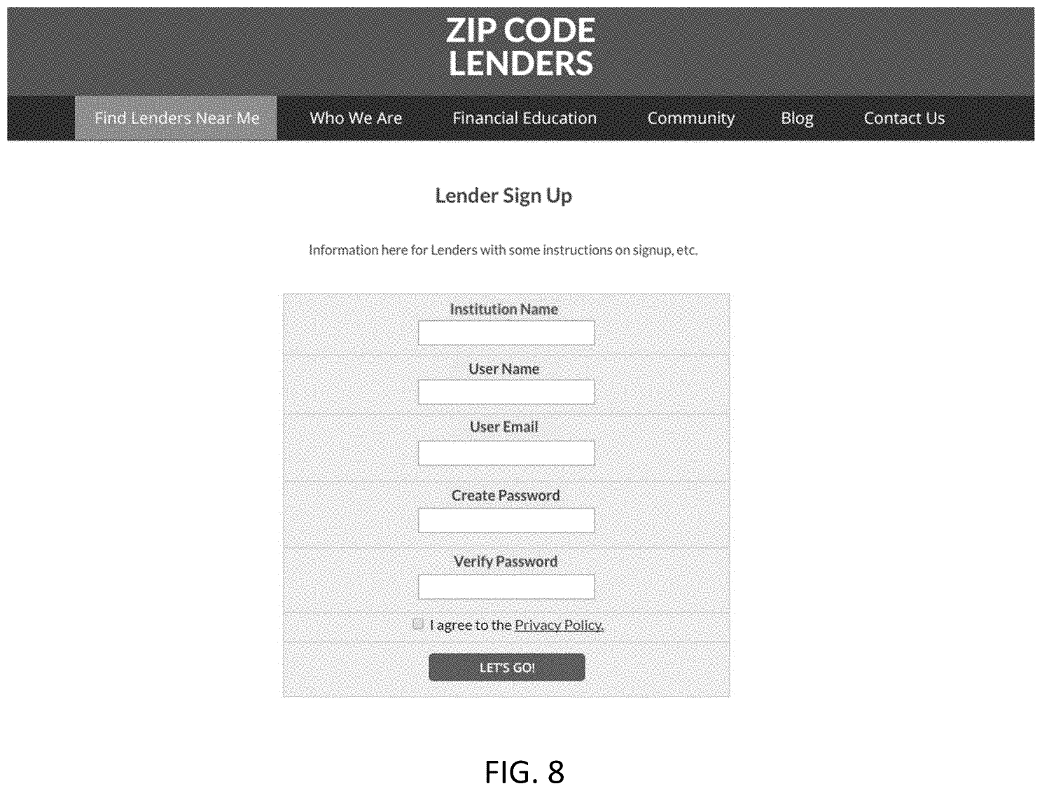

FIG. 8 provides instructions for provider support. The system is capable of providing additional clarity around the roles and requirements for the various participants (OML). This includes the following benefits:
Support more robust small business borrower protections and effective oversight.
Ensure sound borrower experience and back-end operations.
Promote a transparent marketplace for borrowers and investors.
Expand access to credit through partnerships that ensure safe and affordable credit.
Support the expansion of safe and affordable credit through access to government-held data.
Facilitate interagency coordination through the creation of a standing working group for online marketplace lending.
   (OML). The system provides “[c]ommon business rules and technical standards that enable providers to settle and clear cross-platform services” and “enable data sharing and analytics across providers to facilitate product development.” (OML).

As illustrated in FIGS. 9-14, the data analytics middleware includes a reciprocated teaching and learning case analysis between consumer(s) and provider(s). A dialectic method of teaching and learning in a continuous feedback is created through cooperative and logical augmentations in the form of questions and answers stimulating critical thinking and collaboration for new ideas in the consumer financial services sectors, allowing for real business situations. Compiling lists of providers who match their criteria, the user(s) will also be able to review financial service offers by the provider(s) in their communities and/or regional boundaries and have the option to view more detail or select the provider/lender. If a particular provider is selected, both user and provider will be provided with the appropriate contact information, so follow-up can be made.

FIG. 9 is targeted at investor/provider/institution sign-up instructions, information, and marketing. The system is configured to “broaden existing business practices and expand access to credit for borrowers” by providing the following:
a primary mission of promoting community development.
development services in conjunction with financing activities to serve one or more defined target markets.
   (OML). Additionally, the system may also be configured to offers new product, to improve the borrower experience, or to reach new customers (OML).

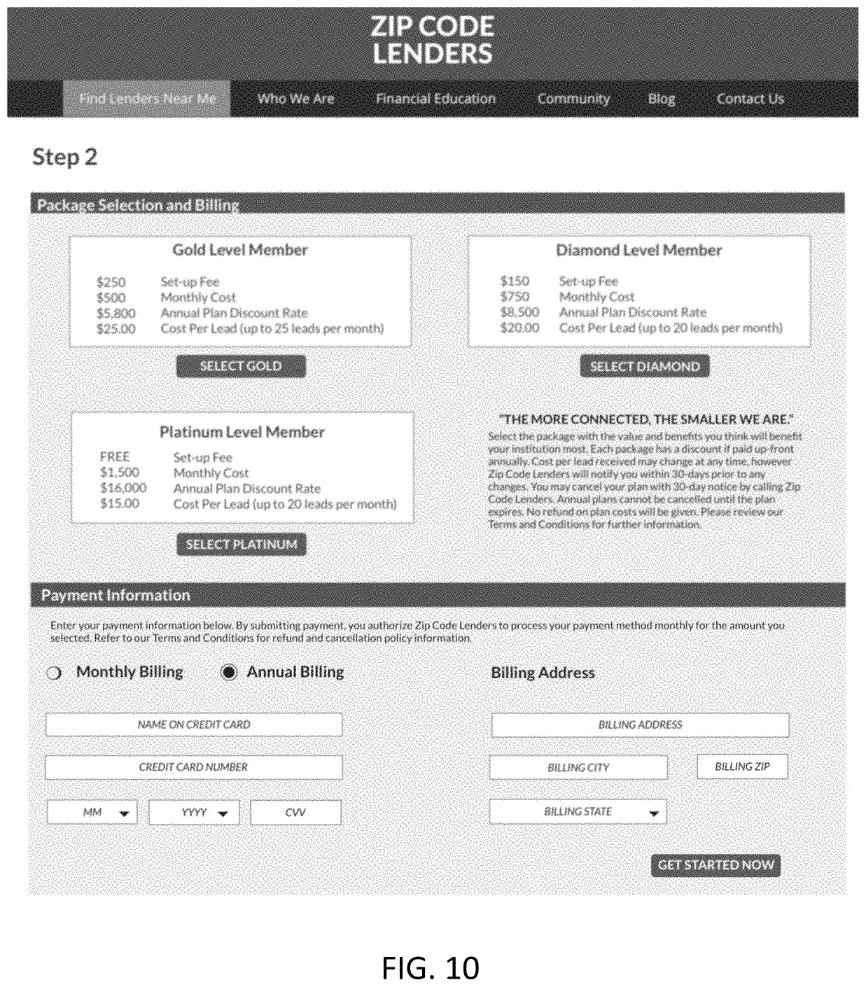

FIG. 10 is targeted at investor/provider support, engagement, and billing information. The use of data for credit underwriting is a core element of an online marketplace and one of the sources of innovation that holds the most promise and risk (OML). Thus, “enhanced safeguards are required: RFI commenters drew attention to uneven protections and regulations currently in place for borrowers with a focus on maintaining accountability to a defined target market” because “active growth of a securitization market will require transparency and significant repeat issuances.” (OML)

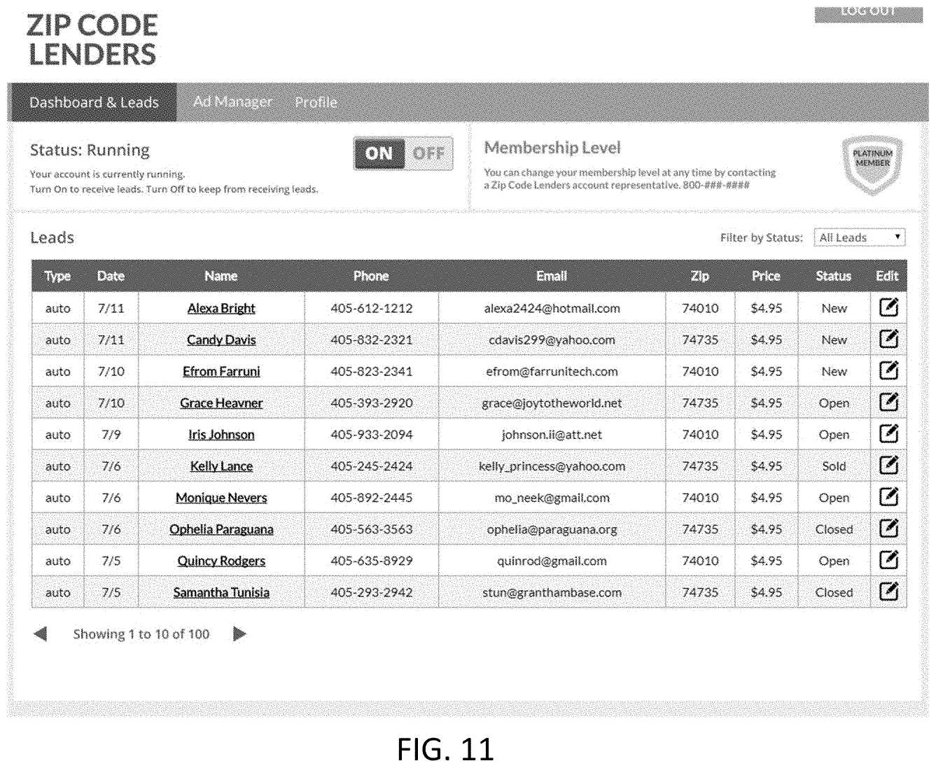

FIG. 11 is focused on a dashboard for provider leads. The system is configured to capture and verify the identity of customers. A virtual account may be provided to enable digital payment connectivity (FI).

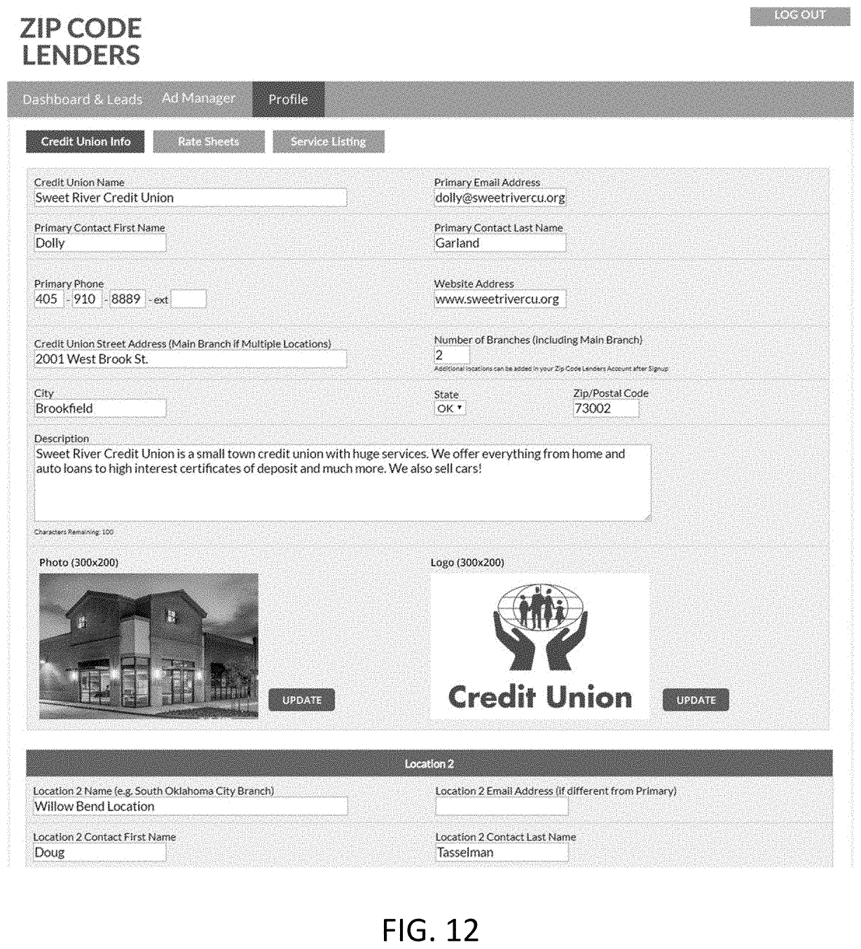

FIG. 12 is targeted at developing a profile and marketing for the provider. The system is configured to “broaden existing business practices and expand access to credit for borrowers.” (OML). Providers may “construct portable financial histories of customers enabling providers to develop customized services that match individuals' unique needs and risk profiles.” (FI).

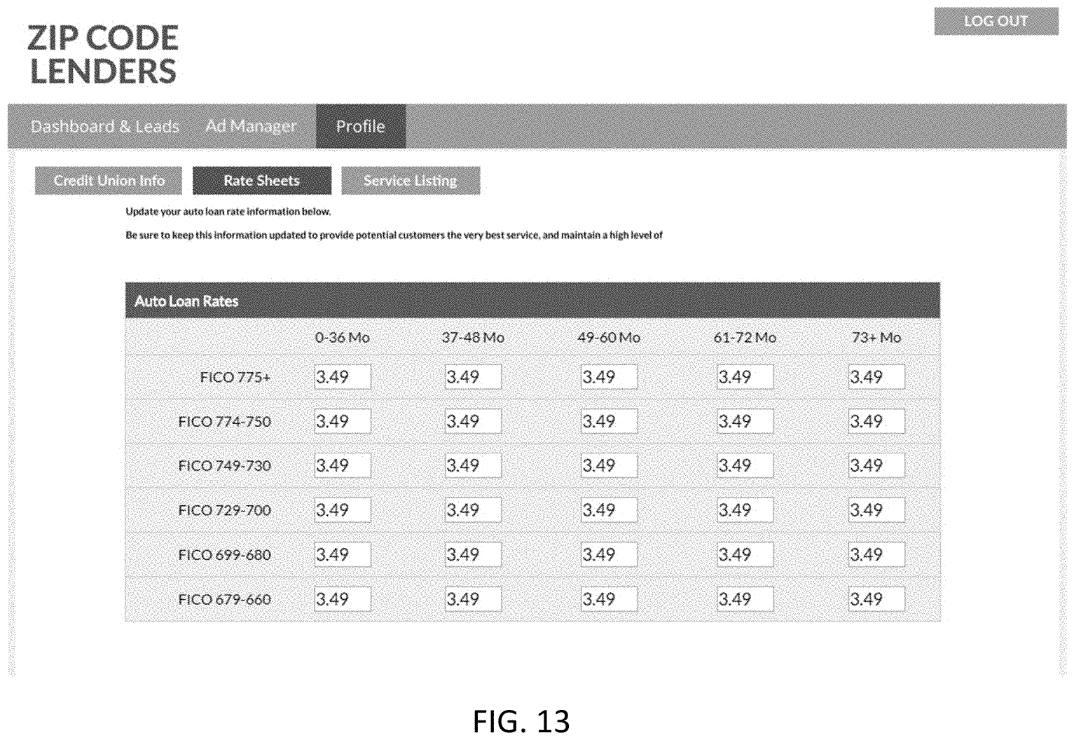

FIG. 13 is focused on provider rates. “Transparancy includes pricing terms for borrowers and standardized loan-level data for investors” (CAC), including the following benefits:
Policies that could minimize borrower risks and increase investor confidence; and
Improve efficiencies and to offer new products.

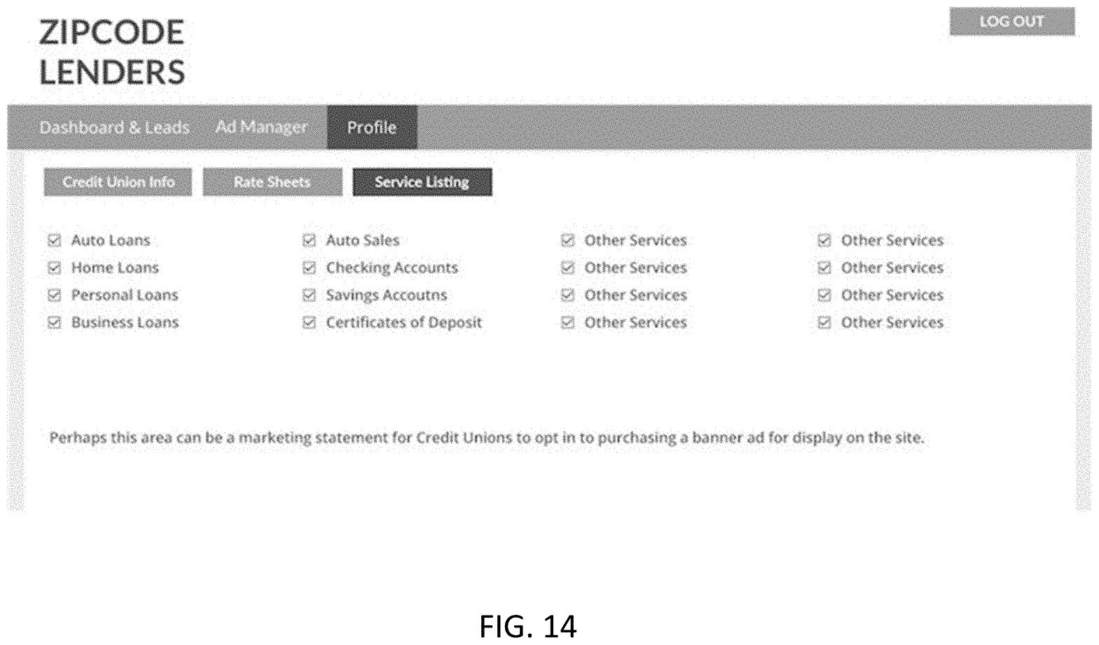

FIG. 14 shows an example of provider services. Using the process and system described, providers may offer new products to improve the borrower experience or to reach new customers (CAC). The primary mission is to promote community development. The system is configured to “broaden existing business practices and expand access to credit for borrowers.” (OML).

### Examples

The system and computer-implemented method for creating digital pathways between financial service providers and consumers disclosed herein is further illustrated by the following example, which is provided for the purposes of demonstration rather than limitation.

The purpose of the inventive system and method is:
Provide Credit Union Finance/Loan LENDERS a real source for legitimate client lead.
Provide USERS seeking auto loans a source for legitimate loan contact with reputable lenders in their area.
Provide lending education to consumers visiting the site by offering resources, links and materials from trustworthy financial entities

Users coming to this website are looking lenders in their area who can help them get an auto loan without stress or hassle. The goal of the inventive system and method is to give users peace of mind when shopping for auto loans, putting them in control by allowing them to choose the lender(s) they wish to hear from.

The frontend website will consist of two sections: Users and Partners. The first section is the USER section. This part of the website will be the “brochure” of the company. It will include the “Who We Are”, “Financial Education”, “Frequently Asked Questions”, consumer financial information and helpful links, and other content that will help those seeking auto loans learn more. Throughout the website, the user will also see carefully vetted advertising chosen and placed on the site to enhance their experience and not overwhelm or frustrate.

The inventive system and method site will allow users to quickly and simply get the information they are looking for. The homepage will have a user-friendly navigation, and a modern look/feel. Final design, look, and feel will be created when the project begins.

The website will be mobile responsive, allowing users to view and navigate the site on any device, using any size screen. The mobile version of the website will be user-friendly. The frontend USER section will consist of a User Form, allowing the user to enter specific information/answers to questions asked. The form will be concise and easy to use. It will encourage users to continue by reminding them that their information will not be shared, and that the lenders shown in their results want to help them have a good auto purchase experience.

Users will fill out a short form to determine their auto loan needs and see which lenders in the system match those needs; then they will have the ability to choose if they want to select the lenders they'd like to have contact them, or if they would like the system to choose for them.

The first screen of the User form will simply ask for the User's Zip Code and vehicle loan type (new or refinance). After the user confirms their agreement to the system's Privacy Policy, they will click to move to the next screen. This simple first step will engage users quickly and easily.

While the example is directed to target auto loan customers, the system could be built to include options for additional financial services such as Mortgage, Insurance, Personal Loans, Student Loans, etc. This would require further detail to determine the questions needed in the User Form process.

The second screen of the User Form will request basic information (amount requested (if known/or pre-approval “up to”), name, email, phone) along with any necessary questions from the lenders. Each lender has different qualifications they may need for loan application, so each will be consulted as they sign up to ensure the user form addresses any required questions. For example, we will need fields for Qualifications, Locations, etc. This will allow any Credit Unions only allowing certain professions or areas to weed out unqualified candidates. Any “additional” question dropdowns will be managed by Super Admins in the Settings tab of the backend (more to follow below). Additional questions could be “Length of Loan Desired”, “Down Payment Amount”.

After the first screen (FIG. 5), the user will see a “preview” of the number of lenders in their area. This teaser will explain that filling out additional information will allow the site to return even more targeted results and lender information. If the user would like to see lender information, they must submit this information to the inventive system and method system. This ensures that the inventive system and method obtains the user's information for marketing purposes, and the user is not able to retrieve the Credit Union member list without fully using the system.

The system should be built in a way that Credit Union information is safeguarded as much as possible while making the gathering of information easy for users.

The second screen (FIG. 6) may have additional questions added, such as estimated down payment amount, Last Four of SSN, employment, etc. to filter results. These questions will be added based on the needs of member credit unions and will be determined during the full project build.

The system may do a ‘soft pull’ credit check on each user to check pre-qualification for Credit Unions. No real authorization is needed, but system would let user know and give them the ability to ‘opt-in’ by going to the second form step. Last four of SSN may be required. This will be determined during design and buildout with more information from the lending institutions.

This screen will also have paid lender advertising on it. These ads will be filtered based on the Zip Code entered on Screen One and will not be clickable. They will be visual ads for impression only. See Ad Manager information below for more detail.

After the second screen, the user will see listing of the lenders who match their criteria.

The third screen (FIG. 7) will show the user their lender results in a clean and concise manner, but without address or contact information. The user will be shown a snapshot of the Credit Union's services offered, then have the option to view more detail or select the lender. If the lender is selected, both the User and the Lender will be notified via email with the appropriate contact information so follow-up can be made. Results will be shown randomly unless a lender(s) has paid for premium listing. Premium Listing will be an add-on feature for lenders that will ensure they show at the top of search results.

This screen will also have paid lender advertising on it. These ads will be filtered based on the Zip Code entered on Screen One and question responses given in Screen Two. If lenders meet Zip Code and response criteria and have an ad running, they will show randomly on this page.

The results page will allow the user to see the LENDERS matching their search criteria. The available LENDER list will be based on the user's location (Zip Code) and responses to additional questions. All matching lenders will receive the user's information.

Each lender result box will show a simplified view of information. The top of the page should have a disclaimer letting the user know the results shown are from partner organizations working directly with the inventive system and method to encourage use of the system.

The user might see the Credit Union logo, city/state, and any basic information they have given (such as hours, online banking, mobile app available, etc.). They will have some quick action buttons to view the Lender Rates if available and to Contact the Lender directly through the system.

This final Lender Results page will also have a confirmation message and the ability for the user to print their lender results list for future reference.

Credit Union Lenders will join the inventive system and method as members. They will join by clicking a link on the homepage and creating an account. This can either be done by the LENDER directly, or with the assistance of the inventive system and method Admin.

In order to begin setting up their account, they will be entered:
Credit Union Name
Credit Union Contact Email
Credit Union Contact Phone
Accept Terms/Privacy Policy, etc

Each of these fields will populate any corresponding fields in the following signup screens.

When the Partner Signup button is clicked at the bottom, the lender will begin setting up their account and selecting their lead preferences.

Basic agency information will be entered on this page:
Credit Union Name (pulled from previous login screen)
Email Address (pulled from previous login screen)
Lender Contact Name (pulled from previous login screen)
Phone Number
License Number (or some other certification number to validate their FDIC???)
Street Address 1
Street Address 2
City
State (dropdown list)
Zip
Number of branches
Description
Photo Upload field (to allow lender to upload a photo of their Log

Additional information such as rates and services offered can be added after signup. This shortens the signup process. Lenders will pay a fee to the inventive system and method for signup, for monthly service, and for each lead they receive. When a lender/Credit Union signs up with the inventive system and method system, they will select their monthly automated payment package or select to pay annually at a discounted rate. Their package will allow them access to the system and determine the number of referrals they may receive per month.

Each lender will sign up for the system on an automated monthly recurring payment. Each month, the system will automatically pull the appropriate amount from the lenders account. To end the monthly recurring charge, the lender must call the inventive system and method to cancel with at least a 30-day notice. We also suggest that annual pay lenders be made aware that refunds are not allowed. After the initial contact information is entered, the lender will choose a level of payment for membership with the inventive system and method.

The final section in the Lender signup process is the payment. Here the lender will enter credit card information, authorize recurring credit card billing, enter billing address, and select if they wish to pay monthly or annually.

Now that the lender has joined the inventive system and method, it's time to get some leads. As users come to the website and begin to search for auto lenders, lender members of the system will begin to see activity on their Dashboard. The Dashboard will show a snapshot of lead activity and account information in a quick view, easy-to-read format.

The sections of the Dashboard are (from top to bottom/left to right):
Account Status: Account status is either:
   On—lender is actively receiving leads
   Off—lender is not receiving leads and account is on hold
Member Level: Quick view badge showing the membership level (gold, platinum, diamond, etc.
Leads: This section allows the lender to view, sort, filter, and track all the leads received from the inventive system and method.
   Lender can filter by lead type
   Lender can search by any field or date
   Each lead will show date of lead receipt, Name of lead, phone number, email address, and Zip Code, along link to view additional details.
   Lender can click the name of each lead to view additional details and information on the user and their request.

Each lead received by a Lender will be shown in their Dashboard. When the lead Name is clicked, the Lead Details screen will appear, giving the Lender full details of the lead. The lead details section will contain contact information, responses to the user form, information on the loan desired, and a Notes section where the Lender

The printable Lead Sheet will give the Lender a one-page (8.5″×11″, US standard Letter sized) printout for each lead. The page will contain all information and detail found on the Lead Details page in a clean and professional format.

On the Account tab, the lender can manage personal and Credit Union contact information. This tab is very simple with the following fields:
Top Left Column—Profile Information (lender)
   First Name
   Last Name
   Title
   Street Address 1
   Street Address 2
   City
   State
   Zip
   Phone
   Fax
   Email Address
   License
Top Right Column—Credit Union Information
   Credit Union Name
   Branch Location
   Status (On/Off)
   Membership Level
   Salesperson (The inventive system and method employee pulled from dropdown of Admins list)
Bottom of the Page—Logo Upload and Description Fields

The inventive system and method system will allow each lender to manually add and update their lending rates within the system to give users a quick look view of loan rates without the need to go to another website. As rates change, the lender will need to come back and update their rates in the system to avoid confusion. This is entirely optional. If no rates are entered, there will be no “View Rates” button on the Lender Results page.

Each Lender will have the ability to list their services for potential customers to see on the Lender Results pages. The Service Listing section will be a simple checkbox area, managed in the CMS Settings by Zip Code Lender Admin Users, allowing the Lender to check the services they offer. If a desired service is not listed, the Lender can request that a Zip Code Lender Admin User add it for them. This will be a simple and efficient process.

The billing tab (no comp) is where the lender will manage payment information and view payment history, invoicing, and transaction information. This section will consist of the following areas:
Card on file: The lender will be able to review, edit, and replace the credit card on file for his recurring payment.
Statements: The lender will be able to click to choose from a dropdown the statement they wish to review, then download the PDF version of the statement, or open it in a browser.
Transactions: This grid will show the history of the lender's monetary transactions with the inventive system and method.
Date of Transaction (FULL YYYY/MM/DD)
Name (DESCRIPTION OF CHARGE)
Monthly Account Renewal
Featured Ad
Account Manager Monthly Fee
Initial Deposit
Amount of transaction (IN USD $##.##)
Billing information: Lender can manage, update, edit billing information quickly and easily.

After signup, a Lender can choose some optional value-added features to enhance the inventive system and method experience. The Add-Ons screen allows them to do this. Add-Ons will be finalized during buildout, but could be Premium Listing or Ad Placements, as described below.

If a Lender wishes to have priority coverage on the User Results screen, they can purchase the Premium Listing Add-On. This Add-On will ensure that when each user form is filled out, the results shown are randomized only AFTER the premium lenders are shown. The lender must match the user's search criteria to show on the results page. If the lender matches and has purchased the Premium Listing Add-On, they will show at the top of the results list. If multiple lenders match and have purchased the Premium Listing Add-On, the premium lenders will show randomly, then non-premium lenders will show randomly.

We may opt to offer multiple tiers of Premium Listings, whereby a lender can choose to be a gold, diamond, or platinum Premium Listing. If so, the algorithm will be updated to reflect the need to show higher tier lenders first. For example: Lender A is a Gold Premium, Lender B is a Diamond Premium and Lender C is a non-Premium lender; all three match User Z's criteria; Lender B would show first, followed by Lender A, then Lender C.

If Lender A is a Gold Premium, Lender B is a Gold Premium and Lender C is a non-Premium lender; all three match User Z's criteria; Lenders A and B would be randomized at the top of the list, then Lender C.

A Lender can purchase a Featured Advertisement to provide a showcase for the lender. Pricing for the Ad will be directly derived from the settings tab. The inventive system and method staff edit pricing in the Ad Settings section, as explained in further detail below.

The Featured Ads can be shown in multiple places on the website. Ads can rotate randomly each time a user visits the site. Lenders will have the opportunity to purchase featured ad space on the Inventive system and method using the Featured Ads tab on the Lender Portal pages. When logged in to the Lender Account Dashboard, the Featured Ads tab will be visible to all lenders. Upon clicking the tab, Lenders will see the Featured Ads screen with the following fields:
Lender Name—prefilled from Lender Account information
Credit Union Name—prefilled from Lender Account information
Phone Number—prefilled from Lender Account information
City—prefilled from Lender Account information
State—prefilled from Lender Account information
Select Ad Location on Website:
   Show Ad on website Homepage
   Show Ad on interior page (any)
   Show Ad on Lender Results page of User Form
Ad Text: (length will be based on the size of the ad, which will be based on the location selected above)
   What would you like your Ad to say?—Lender will enter their requested ad copy for the featured ad. The maximum character count is 255 (show character countdown).
   Would you like to add a photo? (Option to use current photo or upload a new one—photo will be sized automatically to fit the ad sizing requirements)
Ad Length
   72 Hours
   One Week
   One Month
   Ad Cost—predetermined cost shown in this field is based on location of ad placement on website (table in Settings tab to be editable by the inventive system and method Admin.

Example: if Joe Lender wishes to run an ad, he would select the Featured Ads tab, verify his information and update any necessary, select the Ad location (for instance, Any Interior Website Page), and the Ad Length (say One Week). They system would calculate his Ad cost based on the Ad Settings Table in the CMS.

The Featured Ads will be shown in multiple places on the website. Ads will rotate randomly each time a user visits the site.

Homepage ad placement: The full Featured Ad will be shown on the homepage at the bottom of the page. This will not be clickable to avoid users going off-site before using the system.

Lender Results List: The full Featured Lender Ad will be shown on the results page of the User Form.

Interior Website Page ad placement: The full Featured Add will be shown on any interior page of the website (either on the left/right margin or the bottom, depending on design). This will not be clickable to avoid users going off-site before using the system.

Creating the structure of the Inventive system and method and Lender Lead generation system will be a complex task. The backend will be built on's Content Management System (CMS). This will give the inventive system and method staff and website administrators the ability to update the website content quickly and easily.

A Multi-Tab structure will make navigating the various sections of the backend user-friendly and convenient. The backend will consist of the following tabs:
Web Content—contains the website content
Admins—contains the website administrator information, including admin groups; this includes only the inventive system and method staff and Account Managers
Users—the section containing the database of website users who fill out the ‘Find a Lender’ form
Lenders—the section containing the database of Lenders who sign up to get leads from the website
Credit Unions—management of Credit Union Selection (important if allowing lenders from multiple branches of the same CU to join the system)
Ad Manager—the tool that allows lenders to pay for ad space on the website
Reports—the section allowing admins to create and run reports on any stored information in the databases (if you see the word Queries in any of the comps, please replace with Reports)
Settings—the section allowing admin users with permission to edit certain dropdown fields
Emails—the automated email administration system allowing admin to create and edit emails

The standard CMS Web Content tab will allow admin to log in with username and password access and edit website content, update photos, manage website pages, and maintain the look of the Inventive system and method. Each page on the site will have a separate section on which you will use the familiar WYSIWYG or “what you see is what you get” module to easily make these edits.

The second tab in the backend system is the Admins tab. This section will contain the list of administrators and staff of the inventive system and method's website and Lender portal system. Each administrator will have username and password access to the backend system. Access levels will be based on the Group they are in.

The system gives Admin users full access to all webpages and/or all tabs within the backend of the CMS. The Admin user can also create and edit user Groups. Each Group can be assigned to specific pages of the website. Each group can also be assigned to specific tabs. For example, a Group called Account Managers may be created, and this group would be given access to the Lenders tab and Reports tab, only to allow them to administer the Lenders who join the inventive system and method. This allows for targeted and secure user-level controls over your website content. Administrators will only see and have access to the areas of the website they have permission to edit.

As users visit the website and fill out the User Form, their information is collected and stored in the Users section of the database in the CMS.

When an admin clicks the Users tab, they will see the main Users screen, which consists of a listing of all Users. The Admin can search the listings and sort the listings by clicking up/down arrows per column. Clicking the edit icon will open a popup window with the user's full form information details.

As Credit Union Lenders join the inventive system and method by filling out the Lender Setup form, their information is collected and stored in the Lenders section of the database in the CMS. This will be a simple ‘member’ database allowing the inventive system and method admin to view and edit Lender information, tracking details and manage communications with Lenders.

When an admin clicks the Lenders tab, they will see the main Lenders screen, which consists of a listing of all Lenders. The Admin can search the listing. Four filter options are available:
Credit Union Name
Member Level ($)
Account Status

The fields shown for each Lender listing are as follows:
ID
First Name
Last Name
Credit Union
Member Level ($)
Leads
Lender Since
Status

Clicking the edit icon will allow the Admin to view all details and information on the lender and lender account. There is also a button to “Add New Lender” that will allow an Admin to manually add a new Lender to the database.

Each Lender account will contain important basic contact information, along with notes, rankings, and payment information. On the Add/Edit Lender screen, the Admin can view/edit/review all of this information quickly and easily.

When the edit icon next to a Lender's name is clicked on the Lenders tab, the Add/Edit Lender screen will pop up, showing the full information for the Lender including the following:
Name
Phone Number
Address fields
Time Zone (dropdown list)
Account Manager (dropdown from list)
Lender Code
Credit Union Name
Member Level ($)

This screen will also have additional buttons for other lender information screens including:
Payment Options—During the setup process, each Lender will input payment options for recurring payment. Those payment options will be visible on this tab.

A cancel and save/close button will allow the Admin to save changes or to cancel without saving changes to the Lender's information.

When NOTES is clicked on the Add/Edit Lender screen, the Notes modal will pop up, allowing the Account Manager to view all notes on the Lender's account. Notes will allow the Lender to comment to Account Managers quickly and easily. Modal will have the following fields:
Lead Name: The name of the lead/user the lender is filing a note about.
Note Date: Date the note was entered into the system.
Note Type: Dropdown based on field in Settings of CMS. Note Types will be determinedly the inventive system and method staff.
Reason: Dropdown based on field in Settings of CMS. Reasons will be determined by the inventive system and method staff.
Note: The text comment field—limit of 250 characters.
Context: (eyeball icon is clickable) Account Manager will click this icon to view the entire details of the note, in case line item view was too long for column width.
Action:
   Text Bubble: if the note is a general comment, a text bubble will appear allowing the Account Manager to click and return a comment.
   If note is a request for credit, icons will be green or red “thumbs up” and “thumbs down” to allow Account Manager to approve or deny request.
      When either thumb icon is clicked, a “Response to Lender” box will appear allowing the Account Manager to leave an explanation of approval or denial.

On an Agency Tab in the CMS, create an Agency Manager system. This is where a drag/drop functionality will exist for the above page to allow an Admin to add Agencies with Logo image and put them in whatever order they like by dragging and dropping them accordingly. Also will have Admin in the Settings tab of CMS to allow the inventive system and method to “prioritize” results by Credit Union if desired.

Admin will enter information above for each Agency in the settings area of the CMS. Agencies can be drag/drop in the order needed. Agencies will be shown in result based on their location in the list.
Credit Union Name
Credit Union Logo Upload
Membership Requirements
State Located (can be multiple states)

The Ad Manager will allow Lenders to purchase a Featured Advertisement to provide the lender a showcase to users visiting the Inventive system and method. See above for Featured Ad scope. Advertisements will be shown in the same style as Lender Results page, on the homepage, interior pages, and on Agency Selection page. Advertisements will be shown randomly on the homepage, agency selection page, and lender results page.

The Reports tab of the CMS will allow the inventive system and method Admins to create and run reports to gather important and valuable information from your system. The Reports system will be divided into three areas to allow for targeted reporting.

The Settings tab of the CMS will allow Admin users the ability to update and edit certain dropdown menu items on the User Form and Lender Sign Up Form frontend pages. This easy-to-use system makes it possible to handle quick updates of information without the need to contact your programmers. Not all dropdown menu items will be available on the settings tab, as there are some that may cause instability if edited improperly. However, your team will give you a quick, safe access point to update all of the menu item settings possible, giving you even more freedom and flexibility, and most importantly, control over your website.

Each dropdown menu item will be contained in a toggle field. When clicked, the current field data will expand, allowing the Admin to select and edit, even add new items to the list.

The final tab in your CMS is the Emails tab. This area allows you to manage some of the automated emails for the inventive system and method users, Lenders, and staff in one location.

The top section will have pre-created automated emails that will be sent when a form is submitted or an Lender joins The inventive system and method will work with the inventive system and method to create these dynamic, text-based emails prior to launching the site.
Staff Emails (Email Me when):
   A new email will be sent to the inventive system and method staff when a Lender joins the inventive system and method system.
   A new email will be sent to the inventive system and method staff when a Lender messages a comment.
Lender Emails:
   A new email will be sent to the Lender when joining the inventive system and method.
   A new email will be sent to the Lender when they receive a new lead.
   A new email will be sent to the Lender to notify them that their monthly recurring charge is about to be pulled from their account.
Web User Emails:
   A new email will be sent to the Web User when they submit a Lender Info request form will setup a maximum of ten (10) pre-created automated emails for the inventive system and method during Phase I.

The bottom section will allow the inventive system and method staff to manually set up their own automated reminder emails. These emails can be used to contact users six months after their form was submitted, contact Lenders one month after they sign up to remind them of the availability of Featured Ad space, etc. The below project estimate is based on the current understanding of the scope and functionality of the project outlined in the above document and design comps as a custom website front-end website design with responsive mobile scaling to fit Smartphones and Tablets of all shapes and sizes, as well as a front-end signup system, and a back-end Content Management System with the specified nine tabs. The price includes an open, flexible, easy to use content management system on the back end, along with database creation, and training.

As used herein, the term “computer” may refer, but is not limited to a laptop or desktop computer, or a mobile device, such as a desktop, laptop, tablet, cellular phone, smart phone, personal media user (e.g., iPod), wearable computer, implantable computer, or the like. Such computing devices may operate using one or more operating systems, including, but not limited to, Windows, MacOS, Linux, UNIX, iOS, Android, Chrome OS, Windows Mobile, Windows CE, Windows Phone OS, Blackberry OS, and the like.

As used herein, the term “mobile device” may refer, but is not limited to any computer, as defined herein, that is not fixed in one location. Examples of mobile devices include smart phones, personal media users, portable digital assistants, tablet computers, wearable computers, implanted computers, and laptop computers.

The system and process described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The systems and/or processes described herein, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as NET and C++, a lightweight data-interchange programming language such as JavaScript Object Notation (JSON) data-interchange format over HTTP POST request/response, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each process described above, and combinations thereof may be embodied in computer executable code that, when executing on one or more computing devices, performs the steps thereof. In another aspect, the processes may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

It is to be understood that were the specification or claims refer to relative terms, such as “front,” “rear,” “lower,” “upper,” “horizontal,” “vertical,” “above,” “below,” “up,” “down,” “top,” “bottom,” “left,” and “right” as well as derivatives thereof (e.g., “horizontally,” “downwardly,” “upwardly” etc.), such reference is used for the sake of clarity and not as terms of limitation, and should be construed to refer to the orientation as then described or as shown in the drawings under discussion. These relative terms are for convenience of description and do not require that the apparatus be constructed or the process to be operated in a particular orientation.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Processes of the instant disclosure may be implemented by performing or completing manually, automatically, or a combination thereof, selected steps or tasks.

The term “process” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a process comprising two or more defined steps, the defined steps can be carried out in any order or simultaneously (except where context excludes that possibility), and the process can also include one or more other steps which are carried out before any of the defined steps, between two of the defined steps, or after all of the defined steps (except where context excludes that possibility).

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive concept has been described and illustrated herein by reference to certain illustrative embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A computer-implemented method for creating digital pathways between consumers and researchers, the method comprising:
operating a computer system having at least one processor and a graphical user interface;
obtaining consumer data from the consumer via the graphical user interface;
storing the consumer data in a first database;
processing the consumer data to determine at least one variable from the consumer data;
comparing the at least one variable with a dataset saved in a second database; and
determining based on the comparison between the at least one variable and the dataset a desired result.

2. The method of claim 1, wherein the at least one variable is a response to a question.

3. The method of claim 2, wherein the response is added to the dataset in the second database.

4. The method of claim 1, wherein the method further comprises presenting the result to the consumer.

5. The method of claim 1, wherein the method further comprises presenting the result to a researcher via a second graphical user interface.

6. The method of claim 1, the method further comprising:
constructing a hypothesis from the comparison of the at least one variable with the dataset, wherein the at least one variable comprises characteristics of the consumer, wherein the characteristics comprise:
the location of the consumer;
the race of the consumer; and
the financial status of the consumer;
analyzing the hypothesis to draw a conclusion about comparison; and
using the conclusion to construct a new question to be presented to the consumer.

7. A system for creating digital pathways between consumers and researchers, the system comprising:
a processor;
a computer-readable medium storing instructions which, when executed by the processor, cause the processor to perform operations comprising:
providing a consumer with a graphical user interface, wherein the graphical user interface includes at least one question;
receiving a response to the at least one question;
evaluating the at least one question against a data set stored in a database; and
determining based on the evaluation, a conclusion, wherein the conclusion comprises a suggestion to provide the consumer.

8. The system of claim 7, wherein the suggestion comprises a choice of service providers.

9. The system of claim 7, wherein the suggestion comprises marketing materials.

10. The system of claim 7, wherein the operations further comprise:
adding the conclusion to the dataset in the database; and
forming a new question based on the evaluation.

11. The system of claim 10, wherein the operations further comprise presenting the dataset to a researcher.
